(19) United States
(12) Patent Application Publication
(10) Pub. No.: US 2026/0340470 A1
(43) Pub. Date: Oct. 29, 2026

(54) Computer-Implemented Systems for Improved Selection of Subsets of Datasets

(71) Applicant: University of Georgia Research Foundation, Inc., Athens, GA (US)

(72) Inventors: Ping Ma, Athens, GA (US); Wenxuan Zhong, Athens, GA (US); Haoran Lu, Athens, GA (US); Yongkai Chen, Cambridge, MA (US)

(21) Appl. No.: 19/465,711

(22) Filed: Jan. 30, 2026

Related U.S. Application Data
(60) Provisional application No. 63/788,361, filed on Apr. 14, 2025.

(51) Int. Cl. G06N 10/60

(52) U.S. Cl. CPC G06N 10/60

(57) ABSTRACT

A highly versatile ensemble of algorithms, such as Bisection Grover's search (BGS), containing one or more quantum algorithms has been developed for best model selection. Data in the application show that the ensemble of algorithms exhibits excellent performance and computational efficiency in its applications, specifically in the analysis of CITE-seq data. The ensemble of algorithms, such as BGS, takes advantage of quantum parallelism by integrating binary search and Grover's algorithm to allow fast computation. The proposed ensemble of algorithms, such as BGS, is consistent as long as sufficient quantum bits are available, has nearly quadratic speed-up compared to classical algorithms in terms of time complexity.

### CROSS-REFERENCE TO RELATED APPLICATIONS

This application claims the benefit of and priority to U.S. Provisional Application No. 63/788,361 filed on Apr. 14, 2025, the contents of which is incorporated herein in its entirety.

### STATEMENT REGARDING FEDERALLY SPONSORED RESEARCH

This invention was made with government support under R01 GM152814 awarded by the National Institutes of Health, and DMS2124493, DMS2311297, DMS2319279, DMS1903226, DMS2318809, and DMS1925066 awarded by the National Science Foundation. The government has certain rights in the invention.

### FIELD OF THE INVENTION

The disclosed invention is generally in the field of computer-implemented systems (CIS) and computer-implemented methods (CIMs) using the CIS, and specifically in the area of CIS and/or CIMs with improved computing efficiencies and enhanced approaches that select subsets of datasets from larger datasets without requiring an oracle function to determine whether a correct solution has been identified.

### BACKGROUND OF THE INVENTION

Recent breakthroughs in quantum computers have shown quantum advantage (also known as quantum supremacy), that is, quantum computers outperform the classical computers for solving specific problems (Shor 1999; Arute et al. 2019; Zhong et al. 2020; Wu et al. 2021). More importantly, there are already programmable quantum computing devices available to the public, for example, IBM Quantum Experience, Microsoft Quantum, and Amazon Braket. Such quantum devices are commonly known as noisy intermediate-scale quantum (NISQ) devices (Preskill 2018). It is reported that NISQ with a thousand qubits has been released (Castelvecchi 2023). Despite the success of quantum computers, the investigated problems are highly physics-oriented and may not necessarily appeal to researchers in other fields, for example, statistics and data science (Wang 2022). The key challenge in leveraging quantum advantages in these fields is identifying practical applications where the integration of statistical analysis and quantum computing can effectively overcome computational bottlenecks.

The advantages of quantum computing rely on the fact that quantum bits carry more information than classical bits. Different from classical computers built on classical bits having a state of either 0 or 1, quantum computers operate on quantum processing units, quantum bits (or qubits), which can be in a state 0, 1, or both simultaneously due to the superposition property (Nielsen and Chuang 2010). The p qubits create 2P different states for the system that are superposed on each other. The superposition enables researchers to perform computations using all of those 2P states simultaneously, which is also called quantum parallelism. Quantum parallelism circumvents the time/space tradeoff of classical parallel computing through its ability to hold exponentially many units of information in a linear amount of physical space. In addition, a quantum computer has some logic gates, which a classical computer does not have, enabling faster computation than a classical computer (Nielsen and Chuang 2010).

Despite the impressive achievements made possible by quantum computers, quantum algorithms for solving statistical or data science problems are still lacking. This deficiency primarily stems from the fact that many classical optimal algorithms are the culmination of intellectual efforts by generations of scientists. Developing a quantum algorithm that outperforms the classical optimal algorithms is intellectually challenging. In particular, there are significant technical obstacles in developing such quantum algorithms. First, even though quantum computing enjoys quantum parallelism, accessing the result is not straightforward. Taking measurements of a quantum system induces a superposition of quantum states collapsing into one state in a certain probability and permanently changing the state of the system. Second, many quantum algorithms often depend on an oracle function to recognize if an outcome is a solution or not. For example, Grover's algorithm requires an oracle function that can recognize solutions. However, such an oracle function is usually not available in many statistics or data science problems. Third, extensive efforts have been devoted on analyzing the algorithmic aspect of quantum algorithms. In spite of these impressive algorithmic results, the theoretical analysis that addresses statistical aspects of quantum algorithms is still lacking. Without theoretical statistics insight, researchers may not effectively develop new quantum algorithms to tackle data science problems in a principal statistics framework. Therefore, an unmet need exists to develop computer-implemented systems to alleviate one or more of these significant challenges.

Accordingly, it is an object of the invention to provide computer-implemented systems and/or computer-implemented methods with improved capabilities of selecting subsets of data (e.g., features or models) from a larger set, wherein the subset minimizes a statistical model selection criterion.

### BRIEF SUMMARY OF THE INVENTION

The present disclosure involves systems and methods for selecting a smaller dataset from a larger dataset in an efficient manner. For example, computer-implemented systems and methods are provided for selecting a refined subset of features or models from an initial dataset using quantum computing techniques. In one exemplary form, the computer-implemented system utilizes an ensemble of algorithms, including a Bisection Grover's Search (BGS) algorithm, to identify the subset that minimizes a statistical model selection criterion, such as the Bayesian Information Criterion (BIC). Unlike conventional quantum search algorithms, such as Grover's search algorithm, which requires an oracle function to predefine the optimal subset, the disclosed approach eliminates this requirement while achieving enhanced computational efficiency compared to classical methods. In some forms, the refined subset refers to a reduced selection of data points, features, or models that best represent the overall dataset. For example, given a large dataset, such as one containing p genes (e.g., p=1000), which theoretically generates 2P possible subsets of genes, the systems and methods identify the best subset based on a statistical model selection criterion, such as the Bayesian Information Criterion (BIC). This refined subset is chosen to maximize representational accuracy while facilitating computational efficiency, effectively narrowing down the data to its most informative components. In practical terms, the selection process can include evaluating subsets of data to determine which subset provides the most meaningful representation of the original dataset. Thus, less significant data points are removed, while data points that contribute the most to model accuracy and predictive power are retained.

In some forms, the disclosure involves a computer-implemented system (CIS) and/or computer-implemented method (CIM) containing an ensemble of algorithms containing a quantum search algorithm operably linked to a processor containing quantum bits and/or quantum gates. The ensemble of algorithms can be configured to enhance computing efficiency using the processor compared to a classical optimal search algorithm for a corresponding dataset and preferably selects a first smaller dataset (e.g., a refined subset of features or models) from a second dataset in the absence of an oracle function. Preferably, the ensemble of algorithms is configured to perform the following: generate substates corresponding to subsets of data in the second set of data; select from the substates a first substate (e.g., a benchmark state) as an initial best state and calculating a value for the first substate via a statistical model selection criterion; partition all substates into at least two partitions containing oracle states and non-oracle states, based on the value of the statistical model selection criterion for the first substate; and perform one or more operations to generate a new substate and a value calculated for its statistical model selection criterion. Preferably, the new substate replaces and becomes the first substate as a best state if the calculated value for its statistical model selection criterion is less than the calculated value for the first substate's statistical model selection criterion. Preferably, the ensemble of algorithms is configured to select the first state from a random selection of substates, by selecting the substate with the smallest statistical model selection criterion in the random selection of substates. Preferably, the ensemble of algorithms is operably linked to a user interface and configured to output to the user interface data (e.g., a refined subset of features and/or models) corresponding to the first set of data (e.g., first set of features and/or models) as the first smaller dataset (e.g., a refined subset of features and/or models) when the first substate can no longer be replaced by another generated new substate in a subsequent iteration, or to output to the user interface data corresponding to the first substate as the first smaller dataset, when the oracle states are a null set. In some forms, the disclosed system achieves a nearly quadratic speedup in time complexity (e.g., O(√D log³ D) versus O(D) for a classical exhaustive search, where D is the number of possible subsets), thereby facilitating efficient processing of large datasets with numerous feature or model combinations.

In a non-limiting example, a highly versatile ensemble of algorithms, such as Bisection Grover's search (BGS), containing one or more quantum algorithms has been developed for best model selection. Data in the application show that the ensemble of algorithms exhibits excellent performance and computational efficiency in its applications, specifically in the analysis of CITE-seq data. The ensemble of algorithms, such as BGS, takes advantage of quantum parallelism by integrating binary search and Grover's algorithm to enable fast computation. The proposed ensemble of algorithms, such as BGS, is consistent as long as sufficient quantum bits are available, has nearly quadratic speed-up compared to classical algorithms in terms of time complexity.

Data in the examples demonstrate the efficiency of the disclosed CIS and CIM.

Additional advantages of the disclosed method and compositions will be set forth in part in the description which follows, and in part will be understood from the description, or can be learned by practice of the disclosed method and compositions. The advantages of the disclosed method and compositions will be realized and attained by means of the elements and combinations particularly pointed out in the appended claims. It is to be understood that both the foregoing general description and the following detailed description are exemplary and explanatory only and are not restrictive of the invention as claimed.

### BRIEF DESCRIPTION OF THE DRAWINGS

The accompanying drawings illustrate several embodiments of the disclosed method and compositions and together with the description, serve to explain the principles of the disclosed method and compositions.

FIGS. 1A-1E show quantum circuits for illustration. FIG. 1A shows a circuit that encodes an antibody-derived tag (ADT) subset. FIG. 1B shows a circuit to calculate a state loss function g(·). FIG. 1C shows a circuit to flip the sign of oracle states. FIG. 1D shows an assembled circuit for the operation

$${F}_{w}^{g} .$$

FIG. 1E shows a circuit for an operation G_{W} in the BGS algorithm.

FIG. 2 is a geometrical illustration of the two operations in the first rotation step of the BGS algorithm. After taking the diffusion operation Up and the flip operation

$${F}_{w}^{g} ,$$

the initial state vector [symbol] moves to [symbol] , which is closer to the oracle states [symbol] .

FIG. 3A shows the computation time of the BGS algorithm for the experiments conducted in the quantum computing environment. The boxplots of the actual computation time of the replicated experiments are plotted for varying D. The dashed black line denotes the order of the computation time of the exhaustive search O(D). The dashed blue line represents the order of the theoretical computation time upper-bound O(√D (log D)³). FIG. 3B shows the results of the experiments conducted in a quantum simulator. The boxplots of the log-transformed number of rotations of the replicated experiments are plotted for varying D. The dashed black line denotes the order O(D). The dashed blue line represents the order of the theoretical upper bound of the number of rotations O(√D (log D)²).

FIGS. 4A and 4B show comparison of the performance of BGS, Seurat, and SCANPY on the CD14+ Monocytes cells from CBMC data. The evaluation is based on the mean squared error (MSE) and BIC between the predicted and observed values of CD14 RNA expression level across 100 testing datasets. In FIG. 4A, the x-axis represents the number of selected ADTs, while the y-axis represents the log ratio of the MSE for each method compared to the MSE of the proposed BGS algorithm. The red dashed line indicates a ratio of zero. In FIG. 4B, the x-axis represents the number of selected ADTs, while the y-axis represents the log ratio of the BIC for each method compared to the BIC of the proposed BGS algorithm.

FIGS. 5A-5C shows the prediction performance of the 41 cell types is compared for the Seurat and SCANPY methods with respect to the BGS algorithm. The panel size is shown on the X-axis, while the Y-axis represents the log ratio of the evaluation metric of each method compared to that of the proposed BGS algorithm. The evaluation metrics reported are AUC in (FIG. 5A), specificity in (FIG. 5B), and sensitivity in (FIG. 5C). The red dashed line in each plot indicates a ratio of zero, serving as a reference point for comparison.

FIGS. 6A and 6B shows the best four-marker panels selected by the BGS algorithm. FIG. 6A are dot plots of the best panels are presented. Each cell type is represented by a column, with the cell type name displayed in the bottom margin. Within each column, four dots are positioned to represent the best four markers, and their corresponding names are indicated in the left margin. The dots are color-coded as red or blue, representing the positive or negative coefficients of the markers in the corresponding logistic regression model. The size of each dot reflects the strength of the corresponding marker, determined by the absolute value of the coefficient. FIG. 6B shows the best four-marker panel for CD8naive cells (CD8, CD45RA, CD49d, CD244) is shown. The marginal distributions of these markers' expressions are displayed on the top and right margins. Each dot represents a cell, and the color of the dot indicates the cell type. The upper subfigure illustrates the scatterplot of CD8 and CD45RA for all PBMC cells, while the lower subfigure shows the scatterplot of CD49d and CD244 specifically for the screened CD8+CD45RA+ cells.

### DETAILED DESCRIPTION OF THE INVENTION

The disclosed method and compositions can be understood more readily by reference to the following detailed description of particular embodiments and the Example included therein and to the Figures and their previous and following description.

### I. DEFINITIONS

A “quantum bit” (qubit) is the fundamental unit of quantum information. Unlike classical bits, which can be in one of two states (0 or 1), qubits can exist in a superposition of both 0 and 1 states simultaneously. When measured, a qubit collapses to one of the two possible classical states (0 or 1), but until measurement, it can represent a combination of both states. For example, the two states can be denoted by |0> and |1> using Dirac notation. Qubits can also become entangled, which means the state of one qubit can be dependent on the state of another, even if they are physically separated.

“Quantum gates” are the building blocks of quantum circuits. They operate on qubits to transform their states, analogous to logic gates in classical circuits (such as AND, OR, NOT). However, quantum gates can perform more complex operations due to quantum phenomena like superposition and entanglement. Common quantum gates include: Pauli-X Gate (NOT Gate), that flips the state of a qubit. If a qubit is in the state |0>, it flips to |1>, and if it's in the state |1>, it flips to |0>; Hadamard Gate (H Gate), that creates superposition. It transforms a qubit from a state |0> to (|0>+|1>)/√2, or from |1> to (|0>-|1>)/√2; CNOT Gate (Controlled-NOT Gate), a two-qubit gate that flips the state of the target qubit if the control qubit is in state |1>, leaving it unchanged if the control qubit is in state |0>; and Phase Gate, that applies a phase shift to a qubit, altering the amplitude of its superposition.

In quantum computing, an “oracle” is a term of art and describes a black-box function (or circuit) used as input to another algorithm, often representing a specific problem or constraint, allowing quantum search algorithms like Grover's search to identify specific quantum states or solutions. The concept of an oracle is important to many quantum algorithms, especially in cases where finding solutions through exhaustive search or classical methods would be inefficient.

“First Dataset” refers to a dataset from which subsets of features or models are selected.

“Refined subset of features or models” refers to a subset that minimizes a specified statistical model selection criterion, such as BIC.

“Substates” refers to quantum states representing possible subsets of features or models within a dataset.

An “oracle function” in quantum computing refers to a “black-box” function that provides specific information to a quantum algorithm, often allowing it to perform tasks much more efficiently than classical algorithms. The oracle is typically a unitary operation applied to the quantum state, and it encodes a problem-specific function. The concept of an oracle is central to many quantum algorithms, especially in cases where finding solutions through exhaustive search or classical methods would be inefficient.

“Oracle States” refers to substates corresponding to subsets of data (e.g., features and/or models) that yield a statistical model selection criterion value, such as a lower BIC, compared to a first substate (e.g., a benchmark state) subset.

“Non-oracle states” refers to substates corresponding to subsets of data e.g., features or models) that do not improve upon the statistical model selection criterion value of a current benchmark subset.

An “optimal classical search algorithm” refers to a search technique that is the most efficient in terms of time complexity for a given problem, when the problem is being solved on a classical computer. Several different types of search algorithms exist, depending on the context in which they are applied. Some of the most commonly used optimal classical search algorithms include linear search, binary search, interpolation search, exponential search, and jump search.

A “classical computer” is a type of computing device that uses traditional, well-established principles of computation based on binary logic, where data is processed using bits that can exist in one or two states: 0 or 1.

A “quantum amplitude amplification algorithm” is a quantum algorithm used to amplify the probability of a correct solution in unstructured search problems. The main idea behind amplitude amplification is to increase the probability of measuring the correct solution state by iteratively applying a specific procedure to a quantum state. This process significantly reduces the number of queries required compared to classical search methods. Quantum amplitude amplification can form the core of Grover's search algorithm.

A “binary search algorithm” is a classic algorithm used to efficiently find the position of a target value within a sorted array or list. The main idea is to repeatedly divide the search interval in half. If the target value is smaller than the middle element, the search continues in the left half; if the target value is larger, the search continues in the right half. This reduces the time complexity significantly, making binary search much faster than linear search for large datasets.

A “quantum counting algorithm” is a quantum algorithm for counting the number of solutions for a given search problem.

“Operably linked” refers to the connection of at least two components in a system allowing them to work together via technology including, but not limited to, integrated circuits, electrical cables, ethernet, internet, intranet, Bluetooth, near field communication, WiFi, or a combination thereof. In one exemplary form, “operably linked” refers to a functional interaction between two or more components in a system, allowing them to work together to achieve a shared objective.

The term “real-time” refers to data transmission to a user interface of a computer-implemented method, system, tool, or device within 1, 2, 3, 4, 5, 10, 15, 20, or no more than 30 minutes after the computer-implemented method, system/tool/device receives input data. The transmitted data can be a selection of a subset of data from a larger dataset based, in part, on processing input data.

“Error tolerance” refers to a predefined threshold that determines when to stop algorithm iterations.

### II. COMPUTER-IMPLEMENTED SYSTEMS AND METHODS

### A. Computer-Implemented Systems

The present disclosure relates to systems and methods for selecting a smaller dataset (e.g., a refined subset of features and/or models) from a larger dataset in an efficient manner. The systems and methods can be used to provide input on decision-making, reagent development, characterizing cell types in clinical settings (e.g., to enhance treatment protocols, enhance diagnostic capabilities), drug design and discovery, product development e.g., therapeutic device development, supply chain improvement for healthcare products, healthcare data analytics for insurance products, precision medicine and biomarker identification, medical imaging and diagnostics, therapeutic protocol improvement, clinical trial design and patient stratification, and/or telemedicine and remote patient monitoring.

In some forms, the systems and methods can be used in pharmaceutical drug discovery and development to improve the selection of molecular compounds or features from vast chemical libraries during digital screening. In these forms, the systems and methods help the identification of subsets of compounds most likely to exhibit desired therapeutic effects, accelerating the drug discovery pipeline, reducing computational costs, and shortening the time required to identify lead compounds for further testing.

In some forms, the systems and methods can be used in biotechnology and synthetic biology to select improved genetic constructs or metabolic pathways for bioengineering projects, such as the production of biofuels, pharmaceuticals, or other bioproducts. By efficiently searching large design spaces, the disclosed systems and methods can speed up product development, reduces research and development costs, and enhance scalability in synthetic biology applications.

In some forms, the systems and methods can be used in therapeutic device development to improve the selection of design parameters, such as materials, shapes, or configurations, from a wide range of possibilities to meet performance and safety criteria in medical devices like prosthetics or implants. In these forms, the systems and methods can lead to faster prototyping and testing cycles, allowing quicker market entry and improved device functionality.

In some forms, the systems and methods can be used in supply chain development for healthcare products to improve the management of variables like suppliers, logistics routes, or inventory levels to facilitate the efficient delivery of medical products, such as vaccines, drugs, or medical equipment. In these forms, the systems and methods can improve cost-effectiveness and facilitate timely availability of healthcare products, e.g., during emergencies like pandemics.

In some forms, the systems and methods can be used in healthcare data analytics for insurance products to improve the selection of risk factors or patient characteristics from large datasets, refining actuarial models and predicting health outcomes. In these forms, the systems and methods can provide more accurate risk assessments, better pricing strategies, and enhanced risk management.

In some forms, the systems and methods can be used in therapeutic settings such as precision medicine and biomarker identification to analyze high-dimensional patient data, such as genomic or proteomic profiles, to identify key biomarkers for predicting disease risk or treatment response. In these forms, the systems and methods can improve development of personalized diagnostic tools and treatment plans, thereby improving patient outcomes while minimizing ineffective interventions.

In some forms, the systems and methods can be used in medical imaging and diagnostics to improve feature selection in imaging systems like MRI or CT scans to pinpoint the most relevant image regions or characteristics for diagnosing conditions like cancer or neurological disorders. In these forms, the systems and methods can result in faster, more accurate diagnostics, thereby improving early detection and clinical decision-making.

In some forms, the systems and methods can be used in therapeutic protocol development to identify the best combination of treatment parameters, such as drug dosages or therapy schedules, from numerous options. In these forms, the systems and methods can provide more personalized and effective treatment protocols, thereby improving patient care while reducing reliance on trial-and-error methods.

In some forms, the systems and methods can be used in clinical trial design and patient stratification to improve the selection of patient subgroups or trial parameters, such as inclusion criteria or endpoints, enhancing the efficiency and statistical power of clinical trials for new therapies. In these forms, the systems and methods can help reduce trial costs and durations, thereby accelerating the approval of new treatments and bringing innovations to market more quickly.

In some forms, the systems and methods can be used in telemedicine and remote patient monitoring to improve the selection of sensor data or patient metrics to predict health deterioration or trigger timely interventions in remote monitoring systems. In these forms, the systems and methods can improve the efficiency of remote care, reduces unnecessary hospital visits, and enhance patient management, particularly in resource-limited environments.

In some forms, the disclosure involves a computer-implemented system (CIS) containing an ensemble of algorithms containing a quantum search algorithm operably linked to a processor containing quantum bits and/or quantum gates. Preferably, the ensemble of algorithms is configured to enhance computing efficiency using the processor compared to a classical optimal search algorithm for a corresponding dataset. In some forms, the ensemble of algorithms is configured to select a first smaller dataset from a second dataset in the absence of an oracle function, by performing one or more of the following: generating substates corresponding to subsets of data in the second set of data; selecting from the substates a first substate (e.g., a benchmark state) as an initial best state and calculating a value for the first substate via a statistical model selection criterion; partitioning all substates into at least two partitions containing oracle states and non-oracle states, based on the value of the statistical model selection criterion for the first substate; and/or performing one or more operations to generate a new substate and a value calculated for its statistical model selection criterion. It is contemplated that the new substate replaces and becomes the first substate as a best state if the calculated value for its statistical model selection criterion is less than the calculated value for the first substate's statistical model selection criterion. In some forms, the CIS is operably linked to a machine learning platform (e.g., deep learning, unsupervised learning, semi-supervised learning, supervised learning, reinforced learning, etc.). In some forms, the ensemble of algorithms can leverage quantum parallelism to evaluate multiple candidate subsets of features or models simultaneously, thereby improving computational efficiency compared to classical search methods. For example, the ensemble of algorithms includes a BGS algorithm, which integrates a binary search approach with Grover's quantum search algorithm to iteratively refine a benchmark subset. In these forms, a randomly selected subset serves as the benchmark initially, and its statistical model selection criterion (e.g., BIC) is computed. The system can partition all possible subsets into oracle states (such as those with an improved criterion value) and non-oracle states. The BGS algorithm can then apply quantum operations to shift a quantum superposition of all substates toward the oracle states. Upon measurement, the system collapses to a new subset, and this process repeats until a subset is identified that achieves the best balance of model performance, computational efficiency, and statistical criteria, all without requiring an oracle function to predefine the solution.

In some forms, the CIS is as described above, except that the ensemble of algorithms is configured to select the first state from a random selection of substates, by selecting the substate with the smallest statistical model selection criterion in the random selection of substates. In some forms, the ensemble of algorithms is operably linked to a user interface and configured to output to the user interface data corresponding to the first set of data as the first smaller dataset (e.g., a refined subset of features and/or models) when the first substate can no longer be replaced by another generated new substate in a subsequent iteration. The CIS can also be configured to output to the user interface data corresponding to the first substate as the first smaller dataset (e.g., a refined subset of features and/or models), when the oracle states are a null set. In some forms, the ensemble of algorithms contains a quantum amplitude amplification algorithm, a binary search algorithm, a quantum counting algorithm, or a combination thereof. Preferably, the combination includes at least a quantum amplitude amplification algorithm. In some forms, the ensemble of algorithms is configured to bisect all substates into two partitions with one partition containing oracle states and another partition containing non-oracle states. Non-limiting examples of quantum amplitude amplification algorithms that can be included include, but are not limited to Grover's search algorithm, quantum walks and amplitude amplification, quantum amplitude amplification in eigenvalue estimation, quantum approximate optimization algorithm, etc. In a preferred form, the quantum amplitude amplification algorithms include Grover's search algorithm. Non-limiting examples of binary search algorithms that can be included include, but are not limited to classic binary search, binary search for lower bound (first occurrence), binary search for upper bound (last occurrence), etc. Non-limiting examples of quantum counting algorithms that can be included include, but are not limited to Grover's algorithm, Simon's algorithm, Shor's algorithm, Quantum Counting, quantum phase estimation, etc. In some forms, the CIS is as described above, except that the ensemble of algorithms is configured to output the first smaller dataset (e.g., a refined subset of features and/or models) to a user interface in real-time. A user interface preferably includes a digital screen (e.g., a screen of a computing device such as a screen of a smartphone, a laptop, a desktop computer, a watch, a tablet, etc.), an electro-mechanical acoustic system (e.g., electronic speakers), or a combination thereof.

In some forms, the CIS is as described above, except that one or more operations carried out by the ensemble of algorithms involve performing (i) a first superposition (preferably a linear combination) of all states to form a first state vector, (ii) a second superposition (preferably of linear combination) of the oracle states to form a second state vector, (iii) a third superposition (preferably a linear combination) of the non-oracle states to form a third state vector, or a combination of (i), (ii), and (iii), such as (i) and (ii); (i) and (iii); (ii) and (iii); or (i), (ii), and (iii). In some forms, the one or more operations involve determining an angle between the first state vector and the third state vector. In some forms, determining the angle between the first state vector and the third state vector involves using a quantum counting algorithm. In some forms, the one or more operations involve determining a number of times to iterate one or more processes in the ensemble of algorithms based on the angle between the first state vector and the third state vector. In some forms, determining the number of times to iterate one or more processes in the ensemble of algorithms involves using a quantum counting algorithm. In some forms, the one or more operations involve rotating the first state vector toward the second state vector to form a rotated superposition. Preferably, rotating the first state vector toward the second state vector involves a mathematical flip operation, a mathematical diffusion operation, or a combination thereof. In some forms, the one or more operations involve measuring a rotated superposition and forming a new substate. In some forms, the ensemble of algorithms is configured to iterate one or more procedures described herein until a sine value of the angle between the first state vector and the third state vector is less than an error tolerance. The BGS framework enhances feature or model selection by integrating binary search with Grover's algorithm while eliminating the need for an oracle function. This approach improves computational efficiency compared to traditional quantum and classical methods, making it particularly suitable for data-intensive applications such as single-cell multi-omics analysis.

In some forms, the CIS is as described above, except that the second dataset includes biological data (e.g., genomic data, proteomic data, transcriptomic data, lipidomic data, metabolomic data, etc.), medical records data (e.g., demographic data, clinical data, test result variables, etc.), financial variables data (e.g., financial variables data for predicting stock), image classification data, stock market data (e.g., historical stock prices with technical indicators), customer segmentation data (e.g., retail dataset containing demographic, purchasing behavior, and transaction data for customers), logistics data (e.g., scheduling flights after a weather event by analyzing air traffic patterns, available resources, and operational constraints), or a combination thereof. In some forms, the second dataset includes biological data (e.g., genomic data, proteomic data, transcriptomic data, lipidomic data, metabolomic data, etc.). In other forms, the second dataset includes logistical data such as variables related to transportation, supply chain management, and operational planning, such as adjusting flight schedules (e.g., after a weather event) by analyzing air traffic patterns, resource availability, and operational constraints.

In some forms, the CIS is as described above, except that the ensemble of algorithms is configured to calculate one or more values of the statistical selection criterion by fitting a regression model to a substate. In some forms, the statistical model selection criterion involves a Bayesian information criterion, Akaike information criterion, corrected Akaike information criterion, consistent Akaike information criterion, deviance information criterion, cross-validation, likelihood ratio test, information complexity, generalized information criterion, Hanna-Quinn information criterion, minimum description length, or a combination thereof. In some forms, the statistical model selection criterion involves a Bayesian information criterion.

In some forms, the CIS is as described above, except that the ensemble of algorithms includes a state loss function configured to map a state for generated substates.

Also described is a non-transitory computer-readable medium containing one or more computer-executable instructions stored thereon executed by a processor containing quantum bits (qubits) and/or quantum gates. The one or more computer-executable instructions include an ensemble of algorithms operably linked to the processor. The ensemble of algorithms is configured to enhance computing efficiency using the processor compared to a classical optimal search algorithm for a corresponding dataset. The ensemble of algorithms is configured to select a first smaller dataset from a second dataset in the absence of an oracle function, by performing one or more of the following: generating substates corresponding to subsets of data in the second set of data; selecting from the substates a first substate (e.g., a benchmark state) as an initial best state and calculating a value for the first substate via a statistical model selection criterion; partitioning all substates into at least two partitions containing oracle states and non-oracle states, based on the value of the statistical model selection criterion for the first substate; and performing one or more operations to generate a new substate and a value calculated for its statistical model selection criterion. It is contemplated that the new substate replaces and becomes the first substate as a best state if the calculated value for its statistical model selection criterion is less than the calculated value for the first substate's statistical model selection criterion. In some forms of the non-transitory computer-readable medium the ensemble of algorithms is configured to output the first smaller dataset (e.g., a refined subset of features and/or models) to a user interface in real-time. In one exemplary embodiment, the ensemble of algorithms is configured to determine a refined subset of features and/or models from an initial dataset without requiring an oracle function. In this exemplary embodiment, the process can include one or more, optionally all of the following steps. First, the system generates substates, each representing a possible subset of the dataset. A benchmark substate is then selected as an initial reference, and its statistical model selection criterion value (e.g., BIC) is computed. The system subsequently partitions the substates into two categories, i.e., (i) oracle states, which exhibit a more favorable statistical model selection criterion value than the benchmark, and (ii) non-oracle states. Using quantum operations, the system adjusts the superposition of substates to shift toward oracle states, producing a newly identified substate. This iterative process continues, with the benchmark substate being updated whenever a newly generated substate demonstrates a more favorable statistical model selection criterion value. The iterative refinement proceeds until further updates do not yield a substate with a better criterion value, at which point the final subset is selected.

### B. Computer-Implemented Methods

Also described are computer-implemented methods (CIM) that use a computer-implemented system or a non-transitory computer-readable medium described herein. Preferably, the use involves selecting a first smaller dataset (e.g., a refined subset of features and/or models) from a second dataset during which the CIM uses a CIS or non-transitory computer-readable medium described herein to process data corresponding to the second dataset. In some forms, data corresponding to the second dataset are in the form of an orthonormal basis set containing substates corresponding to subsets of data in the second dataset. Preferably for the CIM, ensemble of algorithms implemented therein outputs the first smaller dataset (e.g., a refined subset of features and/or models) to a user interface in real-time.

### C. Computer Hardware Components

The disclosed CIS and/or CIM preferably include one or more computer hardware components. In some forms, these include the integration and functionality of data processing, memory, storage, and power management components. These components can collectively allow the efficient execution of one or more algorithms (e.g., the ensemble of algorithms described herein) applications, data processing, and interaction with peripheral devices, forming the elements of the CIS and/or CIM. Details of some computer hardware components are provided below. These components may be specially customized for a specific application involving the ensemble of algorithms described herein and provide improved computing capabilities compared to hardware on classical computers.

Quantum processor: a quantum computer performs quantum computations by manipulating quantum bits (qubits). Unlike classical processors, which rely on binary bits (0 or 1), a quantum processor operates on qubits that can exist in multiple states simultaneously due to superposition. Quantum processors utilize the principles of quantum mechanics—such as entanglement, superposition, and quantum interference—to process and compute information in ways that classical processors cannot.

Quantum circuits: quantum circuits are composed of a series of quantum gates applied in sequence to manipulate qubits. A controller directs the operations and ensures the right sequence of gates is applied to the qubits,

Quantum interconnects: In some quantum computers, qubits are physically separated, and quantum interconnects provide communication between them. These interconnects can allow quantum entanglement or synchronization between qubits that are part of a quantum register.

Quantum software and control systems: quantum software controls the quantum gates and quantum circuits, ensuring that the quantum computer executes the desired quantum algorithms. This software handles low-level gate control, error correction, and optimization.

Quantum-classical interface: A quantum computer interacts with classical systems for tasks such as input/output operations, intermediate processing, and classical post-processing of results. This interface allows quantum results to be extracted and interpreted by classical computers. Examples of quantum-classical interfaces include, but are not limited to, Arbitrary Waveform Generators, Digital-to-Analog Converters, Analog-to-digital converters, Field-Programmable Gate Arrays, Single Flux Quantum Logic, and Qubit Readout Transceivers.

Power Supply Unit (PSU): The PSU is responsible for converting external electrical power to the appropriate DC voltage levels required by the system components. It ensures stable power delivery and protection from electrical surges, faults, or interruptions. The PSU is typically designed to meet energy efficiency standards and may feature modular cables for improved organization and airflow within the system.

In the literature, many quantum-based feature and model selection methods have been explored. He et al. (2018) leverages the searching abilities of Grover's algorithm and proposes the quantum versions of the forward selection and backward elimination algorithm, achieving quadratic speedup for each step of addition or deletion. Chakraborty et al. (2020) and Li et al. (2022) explore the quantum benefits of graph theory to solve the graph-theoretic feature selection problems. Recently, the promise of high efficiency for solving the quadratic unconstrained binary optimization (QUBO) with quantum optimizers has sparked widespread interest in its study, leading to a surge in research investigating quantum-based feature selection within the QUBO model (Von Dollen et al. 2021; Turati, Dacrema, and Cremonesi 2022; Mücke et al. 2023). Nonetheless, the quantum algorithm specifically designed for the aforementioned global optimization searching problems is still lacking. Furthermore, most existing research focuses on conceptual and theoretical exploration. The practical implications of leveraging quantum computing to enhance our understanding of data (e.g., single-cell multi-omics studies) remain largely unexplored.

To overcome the aforementioned limitations, an ensemble of algorithms, such as BGS, has been developed to select the best subset. In the disclosed systems and/or methods a subset is randomly selected as an initial benchmark subset. Preferably, this benchmark subset bisects all subsets into two partitions, an oracle set composed of subsets having smaller BICs than that of the benchmark subset, and a non-oracle set composed of the remaining subsets. BGS starts with an initial superposition where all candidate subsets are encoded with equal weights. BGS then iteratively updates the superposition toward the oracle set and yields a new superposition. The new superposition is then measured and collapses to a new subset. The BIC of the new subset is compared with that of the benchmark set. If the new subset is better than the benchmark set, the new one replaces the benchmark one. The above procedures are repeated until no more replacements can be made. Different from Grover's algorithm, the disclosed BGS algorithm does not require any oracle function to recognize the best subset.

Aspects of the disclosed systems and methods are as follows. First, quantum parallelism is leveraged by integrating a binary search algorithm and a quantum algorithm (e.g., Grover's algorithm) to design a new iteration algorithm that preferably accesses the outcome only at the end of each iteration. In this way, the power of quantum computing can be greatly harnessed. Second, the disclosed ensemble of algorithms can recognize the best subset in the absence of an oracle function. This relaxation expands the scope of applications and overcomes the obstacle of the impractical assumption that the best subset needs to be known a priori in Grover's algorithm. Third, the quantum algorithm (e.g., Grover's algorithm) is integrated with a quantum counting algorithm to get an improved probability and/or high probability of identifying the best subset.

One theoretical aspect of the disclosure is that the error bound for the ensemble of algorithms (e.g., BGS) is derived, and it is shown that the error can be controlled to be arbitrarily small as long as a sufficient number of qubits are available. Not wishing to be bound by theory, it is believed that this aspect arises from the consequence of powerful quantum parallelism and accurate quantum counting. Further, the time and space complexity of the proposed algorithm are also derived. It should also be noted that a sufficient number of qubits are available from quantum computing platforms to analyze large datasets, i.e., the available of qubits is not a limiting factor to the disclosed systems and methods.

Another aspect of the disclosure involves conducting empirical analysis on a quantum computer and quantum simulator, e.g., an IBM quantum computer and IBM quantum simulator, respectively. The empirical results are consistent with the theoretical analysis and demonstrate the quantum advantage of the proposed ensemble of algorithms over classical algorithms. It is contemplated that other biological datasets and non-biological datasets can be analyzed using the disclosed systems and/or methods.

The disclosed systems and methods of use can be further understood through the following enumerated paragraphs or embodiments.
1. A computer-implemented system (CIS) containing an ensemble of algorithms containing a quantum search algorithm operably linked to a processor containing quantum bits and/or quantum gates, wherein the ensemble of algorithms is configured to enhance computing efficiency using the processor compared to a classical optimal search algorithm for a corresponding dataset,
wherein the ensemble of algorithms is configured to select a first smaller dataset from a second dataset in the absence of an oracle function, by:
   (a) generating substates corresponding to subsets of data in the second set of data,
   (b) selecting from the substates a first substate (e.g., a benchmark state) as an initial best state and calculating a value for the first substate via a statistical model selection criterion
   (c) partitioning all substates into at least two partitions containing oracle states and non-oracle states, based on the value of the statistical model selection criterion for the first substate, and
   (d) performing one or more operations to generate a new substate and a value calculated for its statistical model selection criterion, wherein the new substate replaces and becomes the first substate as a best state if the calculated value for its statistical model selection criterion is less than the calculated value for the first substate's statistical model selection criterion.
2. The CIS of paragraph 1, wherein the ensemble of algorithms is configured to select the first state from a random selection of substates, by selecting the substate with the smallest statistical model selection criterion in the random selection of substates.
3. The CIS of any of the preceding paragraphs, wherein the ensemble of algorithms is operably linked to a user interface and configured to output to the user interface:
(i) data corresponding to the first set of data as the first smaller dataset when the first substate can no longer be replaced by another generated new substate in a subsequent iteration, or
(ii) data corresponding to the first substate as the first smaller dataset, when the oracle states are a null set.
4. The CIS of any of the preceding paragraphs, wherein the ensemble of algorithms contains a quantum amplitude amplification algorithm, a binary search algorithm, and a quantum counting algorithm.
5. The CIS of any of the preceding paragraphs, wherein the ensemble of algorithms is configured to bisect all substates into two partitions with one partition containing oracle states and another partition containing non-oracle states.
6. The CIS of any of the preceding paragraphs, wherein the one or more operations involve performing (i) a first superposition (preferably a linear combination) of all states to form a first state vector, (ii) a second superposition (preferably of linear combination) of the oracle states to form a second state vector, and (iii) a third superposition (preferably a linear combination) of the non-oracle states to form a third state vector.
7. The CIS of paragraph 6, wherein the one or more operations include determining an angle between the first state vector and the third state vector.
8. The CIS of paragraph 7, wherein determining the angle between the first state vector and the third state vector involves using the quantum counting algorithm.
9. The CIS of paragraph 7 or 8, wherein the one or more operations involve determining a number of times to iterate one or more processes in the ensemble of algorithms based on the angle between the first state vector and the third state vector.
10. The CIS of paragraph 9, wherein determining the number of times to iterate one or more processes in the ensemble of algorithms involves using the quantum counting algorithm.
11. The CIS of any of paragraphs 6 to 10, wherein the one or more operations involve rotating the first state vector toward the second state vector to form a rotated superposition.
12. The CIS of paragraph 11, wherein rotating the first state vector toward the second state vector involves a mathematical flip operation, a mathematical diffusion operation, or a combination thereof.
13. The CIS of paragraph 11 or 12, wherein the one or more operations involves measuring the rotated superposition and forming the new substate.
14. The CIS of any one of paragraphs 7 to 13, wherein the ensemble of algorithms is configured to iterate steps (c) and (d) until a sine value of the angle between the first state vector and the third state vector is less than an error tolerance.
15. The CIS of any of the preceding paragraphs, wherein the second dataset contains biological data (e.g., genomic data, proteomic data, transcriptomic data, lipidomic data, metabolomic data, etc.), medical records data (e.g., demographic data, clinical data, test result variables, etc.), financial variables data (e.g., financial variables data for predicting stock), image classification data, stock market data (e.g., historical stock prices with technical indicators), customer segmentation data (e.g., retail dataset containing demographic, purchasing behavior, and transaction data for customers), or a combination thereof.
16. The CIS of any of the preceding paragraphs, wherein the second dataset contains biological data (e.g., genomic data, proteomic data, transcriptomic data, lipidomic data, metabolomic data, etc.).
17. The CIS of any of the preceding paragraphs, wherein the ensemble of algorithms is configured to calculate one or more values of the statistical selection criterion by fitting a regression model to a substate.
18. The CIS of any of the preceding paragraphs, wherein the statistical model selection criterion contains a Bayesian information criterion, Akaike information criterion, corrected Akaike information criterion, consistent Akaike information criterion, deviance information criterion, cross-validation, likelihood ratio test, information complexity, generalized information criterion, Hanna-Quinn information criterion, minimum description length, or a combination thereof.
19. The CIS of any of the preceding paragraphs, wherein the statistical model selection criterion contains a Bayesian information criterion.
20. The CIS of any of the preceding paragraphs, wherein the ensemble of algorithms contains a state loss function configured to map a state for generated substates.
21. The CIS of any of the preceding paragraphs, operably linked to a machine learning platform (e.g., deep learning, unsupervised learning, semi-supervised learning, supervised learning, reinforced learning, etc.).
22. The CIS of any of the preceding paragraphs, wherein the ensemble of algorithms is configured to output the first smaller dataset to a user interface in real-time.
23. A non-transitory computer-readable medium containing one or more computer-executable instructions stored thereon executed by a processor containing quantum bits (qubits) and/or quantum gates, wherein the one or more computer-executable instructions contain an ensemble of algorithms operably linked to the quantum processor, wherein the ensemble of algorithms is configured to enhance computing efficiency using the quantum processor compared to a classical optimal search algorithm for a corresponding dataset,
wherein the ensemble of algorithms is configured to select a first smaller dataset from a second dataset in the absence of an oracle function, by:
   (a) generating substates corresponding to subsets of data in the second set of data,
   (b) selecting from the substates a first substate (e.g., a benchmark state) as an initial best state and calculating a value for the first substate via a statistical model selection criterion,
   (c) partitioning all substates into at least two partitions containing oracle states and non-oracle states, based on the value of the statistical model selection criterion for the first substate, and
   (d) performing one or more operations to generate a new substate and a value calculated for its statistical model selection criterion, wherein the new substate replaces and becomes the first substate as a best state if the calculated value for its statistical model selection criterion is less than the calculated value for the first substate's statistical model selection criterion.
24. The non-transitory computer-readable medium of paragraph 23, wherein the ensemble of algorithms is configured to output the first smaller dataset to a user interface in real-time.
25. A computer-implemented method (CIM) for selecting a first smaller dataset from a second dataset, the CIM involving:
processing data corresponding to the second dataset using the CIS of any one of paragraphs 1 to 22 or the non-transitory computer-readable medium of paragraph 23 or 24.
26. The CIM of paragraph 25, wherein the data corresponding to the second dataset is in the form of an orthonormal basis set containing substates corresponding to subsets of data in the second dataset.
27. The CIM of paragraph 25 or 26, wherein the ensemble of algorithms outputs the first smaller dataset to a user interface in real-time.
28. A computer-implemented system (CIS) containing an ensemble of algorithms including a quantum search algorithm operably linked to a processor with quantum bits and/or quantum gates, wherein the ensemble of algorithms is configured to enhance computational efficiency compared to a classical optimal search algorithm for a corresponding dataset, and wherein the ensemble of algorithms is configured to select a refined subset of features or models from a dataset in the absence of an oracle function by:
(a) generating substates representing possible subsets of features or models in the dataset;
(b) selecting an initial benchmark substate from the substates and calculating its value using a statistical model selection criterion;
(c) partitioning all substates into at least two groups, containing oracle states with better statistical model selection criterion values than the benchmark substate and non-oracle states; and
(d) performing one or more quantum operations to generate a new substate, wherein the new substate replaces the benchmark substate if its statistical model selection criterion value is better, iterating until the refined subset is identified.
29. The CIS of paragraph 28, wherein the ensemble of algorithms is operably linked to a user interface and configured to output to the user interface:
(i) data corresponding to the first set of data as the first refined subset of features or models when the first substate can no longer be replaced by another generated new substate in a subsequent iteration, or
(ii) data corresponding to the first substate as the first refined subset of features or models, when the oracle states are a null set.
30. A non-transitory computer-readable medium containing one or more computer-executable instructions stored thereon executed by a processor containing quantum bits (qubits) and/or quantum gates, wherein the one or more computer-executable instructions include an ensemble of algorithms operably linked to the processor, wherein the ensemble of algorithms is configured to enhance computing efficiency using the processor compared to a classical optimal search algorithm for a corresponding dataset,
wherein the ensemble of algorithms is configured to select a refined subset of features or models from an initial dataset in the absence of an oracle function, by:
(a) generating substates representing possible subsets of features or models in the dataset;
(b) selecting an initial benchmark substate from the substates and calculating its value using a statistical model selection criterion;
(c) partitioning all substates into at least two groups, containing oracle states with better statistical model selection criterion values than the benchmark substate and non-oracle states; and
(d) performing one or more quantum operations to generate a new substate, wherein the new substate replaces the benchmark substate if its statistical model selection criterion value is better, iterating until the refined subset is identified.
31. The CIS, CIM, or non-transitory computer-readable medium of any of the preceding paragraphs applied to CITE-seq data to select the optimal subset of antibody-derived tags (ADTs) that best predict RNA expression levels in single cells. For example, using a dataset of human cord blood mononuclear cells (CBMC), the BGS algorithm identifies a subset of ADTs (e.g., CD4 and CD14) that minimizes the BIC in a regression model of CD14 RNA expression, demonstrating superior performance over classical methods.

It is to be understood that the disclosed systems and methods are not limited to specific software components, specific analytical techniques, or to particular hardware platforms unless otherwise specified, and, as such, can vary. It is also to be understood that the terminology used herein is for the purpose of describing particular embodiments only and is not intended to be limiting.

### EXAMPLES

### Example 1: Bisection Grover's Search Algorithm and its Application in Analyzing CITE-Seq Data

With the rapid development of quantum computers, researchers have shown quantum advantages in physics-oriented problems. Quantum algorithms tackling computational biology problems are still lacking. In this non-limiting example, the quantum advantage is demonstrated in analyzing CITE-seq data. CITE-seq, a single-cell technology, allows researchers to simultaneously measure expressions of RNA and surface protein detected by antibody-derived tags (ADTs) in the same cells. CITE-seq data hold tremendous potential for identifying ADTs associated with targeted genes and identifying cell types effectively. However, both tasks are challenging since the best subset of ADTs needs to be identified from enormous candidate subsets.

To overcome these obstacles, a BGS algorithm was developed for the analysis of CITE-seq data. CITE-seq (Cellular Indexing of Transcriptomes and Epitopes by sequencing) is an innovative technology for studying single-cell biology (Stoeckius et al. 2017). Different from single-cell RNA-seq measuring RNA expression alone, CITE-seq enables researchers to simultaneously measure RNA and surface protein expression in the same cells. In particular, in CITE-seq, surface proteins detected by antibody-derived tags (ADTs) are transcriptomically profiled alongside RNA transcripts using single-cell RNA-seq. By using CITE-seq data of cells, the following two biological problems can be studied: (a) identifying ADTs associated with the targeted genes and (b) designing panels of markers for cell type identifications. Successfully tackling these two problems involves the effective selection of the best subset of ADTs. The best ADT subset selection problem is generically hard with classical computing since it is computationally demanding and time consuming due to the need to evaluate an extensive number of candidate subsets. Even for 30 ADTs, that is, p=30, there are more than one billion candidate subsets, which poses significant challenges for classical algorithms to select the best subset.

Despite the fact that RNAs and proteins are produced from the same genes, they provide some complementary information on cell states due to post-transcriptional and post-translational gene regulation. Since the CITE-seq data is often of high dimension and contains lots of redundant information across different RNAs and ADTs, selecting a parsimonious set of RNAs and ADTs is crucial to leverage the information of the CITE-seq data. The disclosed method identifies a set of ADTs that best explains the variations of the expressions of an RNA in a regression model.

Efficiently identifying immune cell types is a key objective in immunological research and clinical diagnostics. A recent study finds that CITE-seq can effectively identify compact sets of immunophenotypic markers (ADTs) for characterizing different cell types (Hao et al. 2021). Such a set of markers is referred to as a panel. Including too many markers in a panel can result in a decreased signal-to-noise ratio and increased background noise in downstream experimental validation, for example, the spillover-spreading error inherent to the fluorescence in flow cytometry (Ferrer-Font et al. 2021). Here, the best subset of ADTs for each cell type is identified using logistic regressions by setting the cell type of interest as one and other cell types as zero. The resulting panel of ADTs improve accuracy in identifying immune cell populations while significantly enhancing resource allocation.

Statistically, our problem can be described as follows: CITE-seq yields a sample with RNA expressions and p ADT expressions xᵢ,1, xᵢ,2, . . . , xᵢ, p in the ith cell, where i=1, . . . , n and n is the number of cells. In the problem of identifying the ADTs associated with the targeted gene, the expressions of RNA and ADTs is modeled through the linear regression model. Given a specific gene of interest, its expression is represented as yᵢ in the ith cell, serving as the response variable in the regression model. It is contemplated that only a subset, denoted by A, of ADTs co-express with the gene of interest and are used as the predictor variables. In the panel design for the cell identification problem, the logistic regression model was considered. The cell type of the ith cell is denoted by zi, which is either one if it is a cell of interest, or zero otherwise. Once again, it is contemplated that only a subset, denoted by A, of ADTs is the marker for the cell type of interest. The primary research interest is identifying the subset A⊆{1, . . . , p} effectively and efficiently. Here, subset A was chosen using the Bayesian information criterion (BIC) (Schwarz 1978), which is given by

BIC(A)=|A|log n−2 log L(A) equation (1)

where |A| is the subset size, n is the number of cells in the training dataset, L(A) is the maximized value of the likelihood function of the fitted model for the corresponding subset.

### Methods and Results

Bisection Grover's search (BGS) algorithm represents a non-limiting example of the ensembles of algorithms described in the instant disclosure.

### 1. Overview

To select the best subset A that minimizes (1), one possible quantum computing method that can be used is Grover's algorithm (Grover 1996). Grover's algorithm is a quantum search algorithm. The intuition behind Grover's algorithm lies in its ability to leverage quantum superposition to enhance the search process. Grover's algorithm initializes the qubits in a superposition of all possible states, effectively exploring multiple search paths simultaneously. Grover's algorithm then employs a technique known as amplitude amplification (Brassard et al. 2002) to improve the probability of finding the desired solution. This technique involves iteratively applying a sequence of quantum operations to amplify the amplitude of the target state while suppressing the amplitudes of other states. This approach leads to a quadratic speedup compared to classical search algorithms, making it highly efficient for large-scale search problems. However, there are three key difficulties in applying Grover's algorithm to the present problem. First, in the present problem, the oracle state a priori is not known. Consequently, it is not clear how to design Grover's operation. Second, even if the oracle state is known in Grover's algorithm, the number of Grover's rotations needs to be determined accurately. Otherwise, Grover's algorithm may not be as effective as what algorithmic analysis prescribes. Third, theoretical analysis, including error quantification and algorithmic complexity, for taking into account the above two difficulties and uncertainties is still lacking. The details of Grover's algorithm are described in Ping Ma, Yongkai Chen, Haoran Lu & Wenxuan Zhong (13 Nov. 2024): Bisection Grover's Search Algorithm and Its Application in Analyzing CITE-seq Data, Journal of the American Statistical Association, DOI: 10.1080/01621459.2024.2404259, Supplementary Material Section A.2, the contents of which are herein incorporated by reference.

A quantum search algorithm was developed named bisection Grover's search (BGS) to address these difficulties. All subsets of {1, . . . , p} naturally correspond to a state in the orthonormal basis [symbol] ={|b₀ [symbol] , . . . |bₙ₋₁ [symbol] } of a Hilbert space H. Notice that only p qubits are sufficient to represent these states. A state loss function is defined as follows

g(·): H→

[symbol]

g(|bⱼ [symbol] )≡BIC(Aⱼ), (Equation 2)
where state |bⱼ [symbol] ∈ [symbol] B is a vector in H that corresponds to the subset Aⱼ. Hence, the best model corresponds to the state that minimizes the state loss function. It is assumed that there exists a sole oracle state in [symbol] that minimizes g(·). Suppose the oracle state denoted by |b★ [symbol] is unique and satisfies

g(|b★ [symbol] )<g(|bⱼ [symbol] ), for |bⱼ [symbol] ∈B and |bⱼ [symbol] ≠|b★ [symbol] . (Equation 3)

The idea of the proposed BGS algorithm can be sketched as follows. Since the oracle state is unknown, the BGS algorithm randomly selects a state and regards all the states with smaller BICs than that of the selected state as oracle states. In particular, BGS randomly selects a state in [symbol] and calculates its BIC. This state is referred to as the benchmark state. This benchmark state bisects the set of all states into two subsets: a subset of oracle states and a subset of non-oracle states. Oracle states are those states having smaller BICs than the benchmark state, and non-oracle states are all other states. BGS then rotates the uniform superposition of all states via Grover's operations toward the superposition of the oracle states. Once taking the measurement, the rotated superposition collapses to one of the oracle states. If the collapsed state's BIC is smaller than that of the benchmark state, the benchmark state is replaced by it. BGS then iterates the above steps. Otherwise, this collapsed state was output.

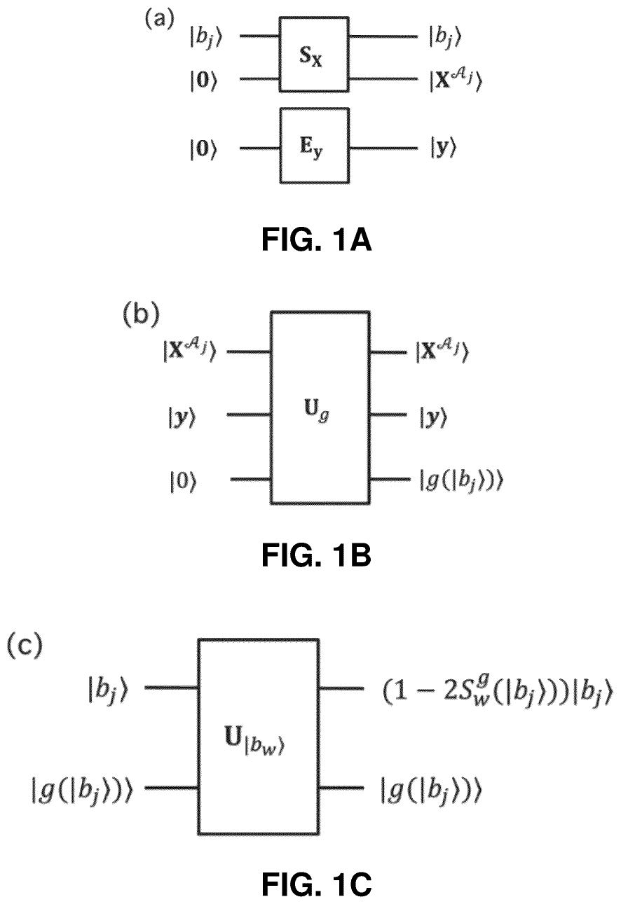

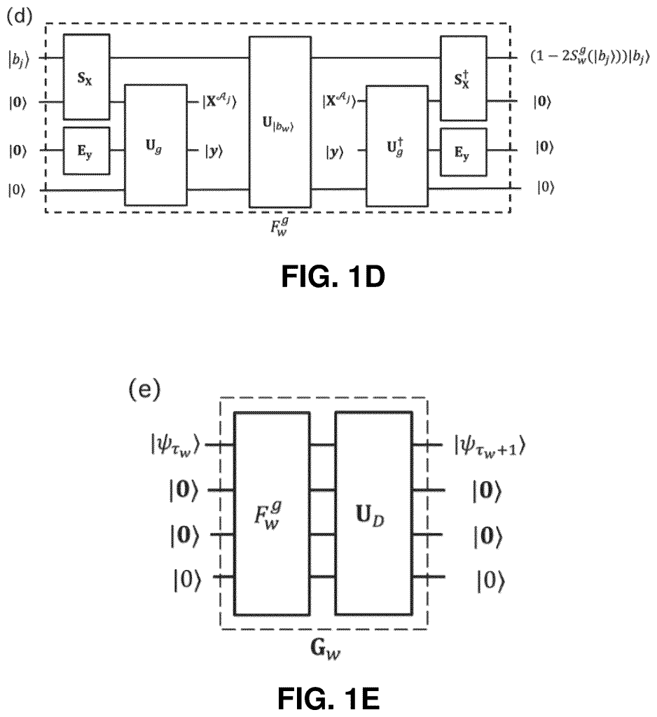

The quantum circuits for evaluation of the state loss function g(·) in all D states are illustrated in FIGS. 1A and 1B. The operation Sₓ encodes the ADTs Aⱼ when the input state is |bⱼ [symbol] . The operation Sy encodes the response y. The state |X^{A}^{ⱼ} [symbol] encodes the matrix X^{A}^{ⱼ} as suggested by Schuld, Sinayskiy, and Petruccione (2016). The operation U_{g} computes the BIC value g(|bⱼ [symbol] ) with the input X^{A}^{ⱼ} and the encoding of the response |y [symbol] . The detailed description of these quantum circuits are provided in are described in Ping Ma, Yongkai Chen, Haoran Lu & Wenxuan Zhong (13 Nov. 2024): Bisection Grover's Search Algorithm and Its Application in Analyzing CITE-seq Data, Journal of the American Statistical Association, DOI: 10.1080/01621459.2024.2404259, Supplementary Material Section B, the contents of which are herein incorporated by reference.
Remark 1: U_{g} can be implemented with quantum speedup. Notice that quantum computing methods for regression and classification offer exponential or polynomial speed-up compared to their classical counterparts (Biamonte et al. 2017), for example, O(log(n)) complexity for fitting linear regression models compared to O(n) complexity in classical computing methods (Schuld, Sinayskiy, and Petruccione 2016) for linear regression.
Remark 2: The advantages of quantum parallelism facilitate the efficient evaluation of the state loss function g(·) in all D states. That is, all D values can be computed simultaneously in a single operation by leveraging the power of quantum computing.

Aspects of the proposed methods are provided below in further detail.

### 2. Bisection and Grover's Operations

BGS randomly chooses an initial benchmark state |b_{w} [symbol] from the set [symbol] . A local evaluation function

$${S}_{w}^{g} ( \vert {b}_{j} 〉 )$$

as

$${S}_{w}^{g} ( \vert {b}_{j} 〉 ) = \{ \begin{matrix}1 , & if g ( \vert {b}_{j} 〉 ) < g ( \vert {b}_{w} 〉 ) \\ 0 , & otherwise\end{matrix} , \qquad ( Equation 4 )$$

Using this local evaluation function, |b_{w} [symbol] bisects basis set [symbol] into two subsets: the subset of oracle states:

$${ℬ}_{W} = \{ \vert {b}_{j} 〉 : {S}_{w}^{g} ( \vert {b}_{j} 〉 ) = 1 \}$$

and the subset of non-oracle states:

$${ℬ}_{w}^{c} = \{ \vert {b}_{j} 〉 : {S}_{w}^{g} ( \vert {b}_{j} 〉 ) = 0 \} .$$

If [symbol] _{w} is a null set, that is, |b_{w} [symbol] happens to be the unique oracle state |b★ [symbol] , BGS can output |b_{w} [symbol] as the final result. If [symbol] _{W} is not empty, BGS proceeds as follows. Let D_{W} be the cardinality of [symbol] _{W}, that is, the number of states in [symbol] _{W}. BGS initializes a uniform superposition as:

$$\vert {ψ}_{0} 〉 = \frac{1}{\sqrt{D}} {\sum }_{j = 0}^{D - 1} \vert {b}_{j} 〉 ≡ \sqrt{\frac{{D}_{w}}{D}} \vert {ϕ}_{w} 〉 + \sqrt{\frac{D - {D}_{w}}{D}} \vert {ζ}_{w} , \qquad ( Equation 5 )$$

where

$$\vert {ϕ}_{w} 〉 = \frac{1}{\sqrt{{D}_{w}}} {\sum }_{j ∈ {B}_{w}} \vert {b}_{j} 〉 and \vert {ζ}_{w} 〉 = \frac{1}{\sqrt{D - {D}_{w}}} {\sum }_{j ∈ {B}_{w}^{c}} \vert {b}_{j} 〉 .$$

Notice that |φ_{w} [symbol] is the linear combination of the oracle states, whereas | [symbol] _{w} [symbol] is the linear combination of the non-oracle states. Define as θ_{w} the angle between |ψ₀ [symbol] and |ζ_{w} [symbol] . By the definition, the equation is:

sin(θ_{w})=\sqrt{D_{w}/D}. (Equation 6)

Since |φ_{w} [symbol] and |ζ_{w} [symbol] are orthonormal, these two super-positions form a two-dimensional Hilbert space. This two-dimensional Hilbert space can be represented as the column space of a 2^{P}×2 matrix Γ_{w}, where the two columns are the corresponding vector representations of |φ_{w} [symbol] and |ζ_{w} [symbol] . The initial state vector then can be written as sin θ_{w}|φ_{w} [symbol] +cos θ_{w}| [symbol] _{w} [symbol] . This state vector can now be rotated toward |φ_{w} [symbol] . Analogous to Grover's algorithm, a flip operation

$${F}_{w}^{g}$$

can be defined, where

$${F}_{w}^{g} \vert {b}_{j} 〉 = ( 1 - 2 {S}_{w}^{g} ( ( \vert {b}_{j} 〉 ) ) \vert {b}_{j} .$$

The implementation details of the flip operation are illustrated in FIG. 1C and FIG. 1D. The operation |U_{|b}_{_{w}} [symbol] [symbol] flips the sign of the input state |bⱼ [symbol] if

$$g ( \vert {b}_{j} 〉 ) < g ( \vert {b}_{w} 〉 ) , i . e . , {S}_{w}^{g} ( \vert {b}_{j} 〉 ) = 1.$$

Consequently, the flip operation can be constructed by assembling the operations for evaluation of the state loss function g(·) and |U_{|b}_{_{w}} [symbol] [symbol] . Notice that to avoid the unnecessary entanglement created by qubits encoding |X^{A}^{ⱼ} [symbol] s and |g(|bⱼ [symbol] ) [symbol] , a standard approach was used by uncomputing the evaluation of the state loss function with the conjugate transpose of the operations S_{X} and U_{g}, that is,

$${S}_{X}^{†} and {U}_{g}^{†} ,$$

respectively.

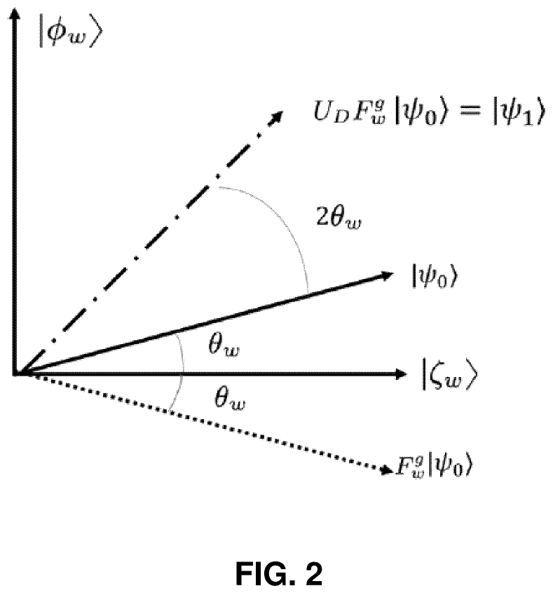

The diffusion operation U_{D} remains the same as the one defined in in Ping Ma, Yongkai Chen, Haoran Lu & Wenxuan Zhong (13 Nov. 2024): Bisection Grover's Search Algorithm and Its Application in Analyzing CITE-seq Data, Journal of the American Statistical Association, DOI: 10.1080/01621459.2024.2404259, Supplementary Material equation (A.8), the contents of which are herein incorporated by reference. Therefore,

$${Grover}^{′} s operation ( with respect to \vert {ϕ}_{w} 〉 ) {G}_{w} = {U}_{D} {F}_{w}^{g} . \qquad Figure 2$$

provides a visualization of the two operations in the first rotation of BGS. It is easy to derive that G_{w} can be decomposed as follows,

$${G}_{w} = {Γ}_{w} ( \begin{matrix}cos 2 {θ}_{w} & sin 2 {θ}_{w} \\ - sin 2 {θ}_{w} & cos 2 {θ}_{w}\end{matrix} ) {Γ}_{w}^{⊤} + {\tilde{Γ}}_{w} {\tilde{Γ}}_{w}^{⊤} , \qquad ( Equation 7 )$$

$$where {\tilde{Γ}}_{w} is a {2}^{P} \times ( {2}^{P} - 2 )$$

matric of which columns are orthonormal and orthogonal with Γ. The detailed derivation can be found in section 6 of Nielsen and Chuang (2010), the contents of which are herein incorporated by reference.

After applying Grover's operation τ_{w} times to it, |φ_{w} [symbol] becomes

|ψ_{τ}_{_{w}} [symbol] =sin((2τ_{w}+1)|φ_{w} [symbol] +cos(2τ_{w}+1)θ_{w})| [symbol] _{w} [symbol] . (Equation 8)

As long as (2τ_{w}+1)θ_{w}≤π/2, BGS gradually amplifies the amplitudes of the oracle states and suppresses the amplitudes of non-oracle states. Notice that all the states' amplitudes are updated simultaneously in this procedure, resulting in highly efficient searching.

Once a measurement is taken, |ψ_{τw} [symbol] collapses to a state |b_{w}_{^{new}} [symbol] ∈B_{w}. The probability that |b_{w}_{^{new}} [symbol] =|bⱼ [symbol] is

$$P ( \vert {b}_{{w}^{n e w}} 〉 = \vert {b}_{j} 〉 ) = \frac{{sin}^{2} ( ( 2 {τ}_{w} + 1 ) {θ}_{w} )}{{D}_{w}} , if {S}_{w}^{g} ( \vert {b}_{j} 〉 ) = 1 ,$$

$$\frac{{cos}^{2} ( ( 2 {τ}_{w} + 1 ) {θ}_{w} )}{D - {D}_{w}} , otherwise .$$

Now the output is

$$\vert {b}_{{w}^{n e w}} 〉 = \vert {b}_{j} 〉 . If {S}_{w}^{g} ( \vert {b}_{j} 〉 ) = 0 ,$$

BGS does not update benchmark state |b_{w} [symbol] . Otherwise, that is

$${S}_{w}^{g} ( \vert {b}_{j} 〉 ) = 1 , BGS$$

replaces benchmark state |b_{w} [symbol] by |b_{w}_{^{new}} [symbol] , that is, updates |b_{w} [symbol] to an oracle state.

The quantum circuit for implementing Grover's operation G_{w} is visualized in FIG. 1E.

### 3. Estimating the Number of Grover's Operations

BGS only updates the benchmark state if the superposition collapses to an oracle state. By (9), the probability that the superposition collapses to an oracle state is the highest if (2τ_{w}+1)θ_{w}=π/2. Thus, the efficiency of BGS highly depends on the choice of τ_{w}, the number of Grover's operations. Since θ_{w} is also unknown, a proper choice of τ_{w} relies on an accurate estimate of θ_{w}. Note that θ_{w} cannot be estimated from (6) since B_{w} is also unknown.

It is proposed to estimate θ_{w} using the quantum counting algorithm (Brassard, Høyer, and Tapp 1998). Since the presentation of the quantum counting algorithm is lengthy, the details are described in Ping Ma, Yongkai Chen, Haoran Lu & Wenxuan Zhong (13 Nov. 2024): Bisection Grover's Search Algorithm and Its Application in Analyzing CITE-seq Data, Journal of the American Statistical Association, DOI: 10.1080/01621459.2024.2404259, Supplementary Material Section A.3, the contents of which are herein incorporated by reference. The key idea of the quantum counting algorithm is sketched as follows. Since 0≤θ_{w}<π, the T-digit binary approximation of θ_{w} is

$${θ}_{w} / π = 0 . {e}_{1} {e}_{2} … {e}_{T} = {\sum }_{k = 1}^{T} {e}_{k} {2}^{- k} ,$$

where eₖ is either 0 or 1. The quantum counting algorithm employs a divide-and-conquer strategy by dividing the problem of estimating θ_{w} into T sub-problems of estimating each digit eₖ separately for k=1, . . . , T, with T additional (auxiliary) qubits. The estimates of eₖ for k=1, . . . , T are then summed together yielding the estimate of θ_{w}. T auxiliary qubits refer to the rotation register. Technically, the information of θ_{w} is first passed on to each auxiliary qubit in the rotation register. The amplitude of the uniform superposition in each auxiliary qubit is then varied with respect to θ_{w} so that the probability of measuring the corresponding eₖ is amplified.

Passing the information of θ_{w} to an auxiliary qubit in the rotation register can be achieved via the controlled Grover operation. The controlled Grover operation acts on the joint system of one auxiliary qubit in the rotation register and the BGS register, which consists of the qubits for running BGS. In particular, the auxiliary qubit in the rotation register is initialized in the uniform superposition state, that is,

$$\frac{1}{\sqrt{2}} ( \vert 0 〉 + \vert 1 〉 )$$

. Applying the controlled Grover operation is equivalent to applying the Grover operation to the BGS register only if the auxiliary qubit in the rotation register is in the state |1 [symbol] . In this way, a single controlled Grover operation rotates the auxiliary qubit by an angle 2θ_{w} Additional technical details are provided in Ping Ma, Yongkai Chen, Haoran Lu & Wenxuan Zhong (13 Nov. 2024): Bisection Grover's Search Algorithm and Its Application in Analyzing CITE-seq Data, Journal of the American Statistical Association, DOI: 10.1080/01621459.2024.2404259, Supplementary Material Section A.1, the contents of which are herein incorporated by reference. Repeatedly applying different numbers of controlled Grover operations is necessary to solve different sub-problems. For example, applying 2^{k-1} controlled Grover operations is needed to estimate eₖ. The inverse quantum Fourier transform (QFT) is then applied to each auxiliary qubit, the measurement of which is the solution of the corresponding sub-problem with a high probability. Finally, the measurement of the joint system of the rotation register and the BGS register is used to estimate θ_{w}.

Using the quantum counting algorithm, the estimate of θ_{w} is obtained, denoted by \hat{θ}_{w}. By (6), the number of oracle states was estimated via \hat{D}_{w}=[D sin²(\hat{θ}_{w})], where [·] denotes rounding to the nearest integer. Hence, the estimate of the number of iterations is

$${\hat{τ}}_{w} = [ \frac{π}{4 arcsin ( \sqrt{{\hat{D}}_{w} / D} )} - \frac{1}{2} ] . \qquad ( Equation 10 )$$

The estimation error of the quantum counting algorithm is established in the following lemma. The proof of this lemma is provided in Ping Ma, Yongkai Chen, Haoran Lu & Wenxuan Zhong (13 Nov. 2024): Bisection Grover's Search Algorithm and Its Application in Analyzing CITE-seq Data, Journal of the American Statistical Association, DOI: 10.1080/01621459.2024.2404259, Supplementary Material Section A.3, the contents of which are herein incorporated by reference.

Lemma 2.1. Let \hat{θ}w be the estimate of θ_{w} using the quantum counting algorithm with T qubits in the rotation register. Assuming that

$${θ}_{w} ∈ ( 0 , \frac{π}{4} ) ,$$

$$P ( \frac{1}{π} \vert {\hat{θ}}_{w} - {θ}_{w} \vert > ε + \frac{1}{2 T} ) < \frac{1}{{2}^{T + 1} ε} . \qquad ( Equation 11 )$$

The computational complexity of this quantum counting algorithm is O(p2^{T}). Remark. The condition of

$${θ}_{w} ∈ ( 0 , \frac{π}{4} )$$

implies that there are less than half of the states that have smaller BICs than the benchmark state. To satisfy this condition, a simple approach can be taken to choose the benchmark state. Instead of randomly selecting one state as the benchmark state, several states were selected and the one with the smallest BIC was chosen as the benchmark state. For example, if m states are randomly selected, then the condition is satisfied with the probability

$$1 - \frac{1}{{2}^{m}} ,$$

which is close to 1 for a moderate m.

The computational complexity of the quantum counting algorithm is of linear order in p and exponential order in T. Moreover, it was shown that the computational cost of the quantum counting algorithm is of the lower order compared to the overall computational cost of the BGS algorithm.

### 4. BGS Algorithm

Aspects of BGS are summarized in Table 1.

Note that at the beginning of each iteration, that is, (b1) in Algorithm 1, the quantum state is always initialized at the uniform superposition of all states specified in (5). This is due to the no-cloning theorem (Wootters and Zurek 1982), which states the impossibility of creating an independent and identical copy of an arbitrary unknown quantum state. This feature distinguishes the iterative algorithms in quantum computers from those on classical computers.

Furthermore, iterations in the BGS algorithm are terminated if sin(\hat{θ}_{w}) is less than an error tolerance δ. By (6), the value of sin(\hat{θ}_{w}) dictates the number of oracle states D_{w}. If sin(θ_{w})=0, there is no oracle state, that is, D_{w}=0. Hence, the benchmark state|b_{w} [symbol] must be the solution state |b★ [symbol] in the BGS algorithm. If sin(θ_{w})=\sqrt{1/D}, there is one oracle state, that is, Dw=1. In that case, the BGS algorithm may yield a state with the second-best BIC value. The larger the value of sin(θ_{w}), the higher the probability that the BGS algorithm yields an inaccurate estimate. However, smaller sin(θ_{w}) implies more iteration steps and longer computation time. Thus, one may set an appropriate error tolerance δ in the iteration stopping rule to strike a balance between estimation accuracy and computational cost.

TABLE 1
Algorithm 1 for Bisection Grover's Search

```
Algorithm 1 Bisection Grover's Search
Input: An orthonormal basis set [symbol]    of size D = 2^{p}, a state loss function g(·) that maps
a state in [symbol]    defined in (2), initial benchmark state |b_{w} [symbol] , and error tolerance δ.
$Initialization : Define a local evaluation function {S}_{w}^{g} ( \cdot ) such that {S}_{w}^{g} ( \vert {b}_{j} 〉 ) = 1. if$
$g ( \vert bj 〉 ) < g ( \vert {b}_{w} 〉 ) and {S}_{w}^{g} ( \vert {b}_{j} 〉 ) = 0 if g ( \vert bj 〉 ) \geq g ( \vert {b}_{w} 〉 ) .$
  (a). Use the quantum counting algorithm to get the initial estimates θ_{w} and \dot{t}_{w}.
Repeat
  repeat
        (b1). Repeatedly apply Grover’s operations defined in (7) for [symbol]  times.
        (b2). Measure the quantum register and denote the measurement result by
    |bw [symbol]
  $until {S}_{w}^{g} ( \vert {b}_{{w}^{n e w}} 〉 ) and update {S}_{w}^{g} ( \cdot ) accordingly .$
      $( c ) . Set \vert {b}_{w} 〉 = ( \vert {b}_{{w}^{n e w}} 〉 ) and update {S}_{w}^{g} ( \cdot ) accordingly .$
      (d). Use the quantum counting algorithm to get the updated estimates \hat{θ}_{w} and \hat{τ}.
      until sin(\hat{θ}_{w}) ≤ δ.
Output: The final benchmark state |b_{w} [symbol] .
```

### 5. Theoretical Analysis

In this section, the theoretical analysis for the proposed BGS method is presented. Theoretical results were established for estimation error and computational cost. The theorems also provide guidance for selecting the parameters, that is, error tolerance δ and the rotation register's number of qubits Tin Algorithm 1. Proofs for this section are provided in Ping Ma, Yongkai Chen, Haoran Lu & Wenxuan Zhong (13 Nov. 2024): Bisection Grover's Search Algorithm and Its Application in Analyzing CITE-seq Data, Journal of the American Statistical Association, DOI: 10.1080/01621459.2024.2404259, Supplementary Material Section C, the contents of which are herein incorporated by reference.

The following theorem is on the estimation error of BGS.

Theorem 3.1 (Estimation error of BGS): Assume all the conditions in Lemma 2.1 are satisfied. If the error tolerance

$$δ < \frac{1}{\sqrt{D}} ,$$

and the rotation register's number of qubits

$$T = Ω ( log \frac{log D}{1 / \sqrt{D - δ}} ) ,$$

the final output state |bw [symbol] has the following error bound,

$$P ( \vert b\_w 〉 \neq \vert {b}^{⋆} 〉 ) {<}_{∼} \frac{log D}{{2}^{T} ( \frac{1}{\sqrt{D}} - δ )} . \qquad ( Equation 12 )$$

Remark. If the error tolerance violates δ≥1/\sqrt{D}, equation (12) no longer holds, and the error probability P (|bw [symbol] ≠|b★ [symbol] ) is lower bounded by a constant close to ½. Additional details are described in Ping Ma, Yongkai Chen, Haoran Lu & Wenxuan Zhong (13 Nov. 2024): Bisection Grover's Search Algorithm and Its Application in Analyzing CITE-seq Data, Journal of the American Statistical Association, DOI: 10.1080/01621459.2024.2404259, Supplementary Material Proposition C.5, the contents of which are herein incorporated by reference.

Under a slightly stronger condition on δ, a more explicit relationship between the error bound and D as well as T can be established.

Corollary 3.2: Suppose all the conditions in Theorem 3.1 are satisfied. If \sqrt{Dδ} is further required to be upper bounded away from 1, that is,

$$δ \leq \frac{( 1 - c )}{\sqrt{D}}$$

for some positive constant c<1,

$$P ( \vert bw 〉 \neq \vert {b}^{⋆} 〉 ) \tilde{<} \frac{\sqrt{D log D}}{c {2}^{T}} \qquad ( Equation 13 )$$

Remark. Since D=2p, (13) can be rewritten as

$$P ( \vert bw 〉 \neq \vert b * 〉 ) {<}_{∼} p {2}^{\frac{P}{2} = T} / c .$$

Note that the condition

$$T = Ω ( log \frac{log D}{1 / \sqrt{D - δ}} ) and δ \leq ( 1 - c ) / \sqrt{D δ}$$

together imply that T=Ω (log({square root over (D log D))}). Thus, (13) indicates that the error probability P(|bw [symbol] ≠|b* [symbol] ) can be controlled to be arbitrarily small with a proper T of the order Θ (log(\sqrt{D log D})). According to Theorem 3.1 and Corollary 3.2, guidance can be provided for selecting the error tolerance δ and the number of qubits T in the rotation register. Note that the estimation error (13) diverges if T is too small, while the computation is too expensive if T is too large. Thus, setting is suggested T=[log(\sqrt{D log D})+5] in practice. As for δ, intuitively, a small δ requires more iterations for the algorithm to converge. Hence, δ=1/\sqrt{2D}, is set, which is bounded away from 1/\sqrt{D} but not too close to zero.

The following theorem regarding the computational cost of BGS is further established.

Theorem 3.3 (Time and Space Complexity): Under all the conditions of Lemma 2.1, if T=Θ(log(\sqrt{D log D})) and δ=1/\sqrt{2D}: The expected time complexity of Algorithm 1 is O(\sqrt{D}(log D)³); (2) the space complexity of Table 1 is O(log(\sqrt{D}log D)).

Remark. Given the stochastic nature of quantum measurement outcomes and the heuristic-based iterative approach of BGS, the time complexity is random. Therefore, the upper bound of the expected time complexity. On a quantum computer, the time complexity of one rotation operation is O(log D) (Koike and Okudaira, 2009). The proposed BGS algorithm requires O(\sqrt{D}(log D)²) rotations in expectation.

Search algorithms in classical computers usually have a time complexity of O(D). Thus, the exemplary BGS method provides a nearly quadratic speed-up. When D is large, this improvement over classical algorithms is very significant. Moreover, Grover's algorithm has a time complexity of O(\sqrt{D log D}). The time complexity of the BGS has a moderate increase over that of Grover's algorithm while not requiring the oracle state as input.

### 6. Empirical Performance

The empirical performance of the BGS algorithm was assessed through simulation studies using IBM Quantum Experience. Since IBM Quantum Experience only offers seven qubits for public access, the performance of BGS was evaluated by varying the number of predictors up to the maximum available in the real quantum computing environment. In addition, IBM provides a quantum simulator to mimic the real quantum computing environment. The performance of BGS was evaluated for a relatively large number of predictors using the simulator.

The proposed BGS algorithm was implemented using a Qiskit Python development kit provided by IBM Quantum Experience. The performance of the BGS algorithm was assessed in both linear regression models and weighted logistic regression models. The results of linear regression models are presented here. The results of weighted logistic regression models are provided in Ping Ma, Yongkai Chen, Haoran Lu & Wenxuan Zhong (13 Nov. 2024): Bisection Grover's Search Algorithm and Its Application in Analyzing CITE-seq Data, Journal of the American Statistical Association, DOI: 10.1080/01621459.2024.2404259, Supplementary Material Section D, the contents of which are herein incorporated by reference.

For the linear regression model, replicated samples are generated according to

$${y}_{i} = {x}_{i}^{T} β + {∈}_{i} , i = 1 , … , n , \qquad ( Equation 14 )$$

where (yᵢ∈R, xᵢ∈R^{p}, β=(β₁, . . . , β₂)^{T}∈R^{p}, and ∈₁∈R.

The following algorithm was set:

$$( n = 1000 ) , {\{ {x}_{i} \}}_{i = 1}^{n} {lid}_{∼} {N}_{p} ( 0 , Σ ) , the ( i , j ) the entry of Σ equals {0.7}^{\vert i - j \vert} . The first [ p / 2 ]$$

entries in β are set to 1, while the remaining entries are set to 0.

$${σ}^{2} = \frac{1}{3} {β}^{T} Σ β$$

is set, and

$${\{ {x}_{i} \}}_{i = 1}^{n} {lid}_{∼} N ( 0 , {σ}^{2} ) .$$

Ten replicated samples were generated for each p∈{3, 4, 5, 6, 7} for real quantum computing, and 100 replicated samples for each p={6, 7, . . . , 15} for quantum simulation. The BGS algorithm was applied to these samples and its performance compared with the best subset selection (BSS) via an exhaustive search.
a. Computational Complexity

Theorem 3.3 states the time complexity of our proposed BGS algorithm is O(\sqrt{D}(log D)³). In particular, the time complexity of Grover's rotation is O(log D), and BGS needs O(\sqrt{D}(log D)²) of rotations.

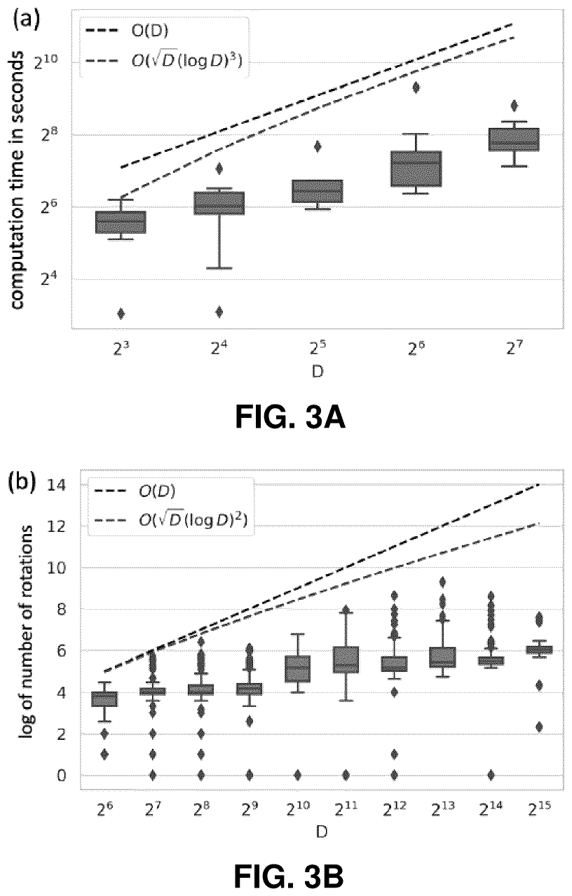

In FIG. 3A, the actual computation time of the BGS algorithm is plotted for a limited range of D conducted in the quantum computer. Next, the empirical computational complexity of the proposed BGS was examined for a larger range of D in the quantum simulator. Due to the fact that the quantum simulator is realized by a classical computer, some quantum steps are implemented through classical computational methods. For example, Grover's rotation is implemented via multiplying a D×D rotation matrix with a D-dimensional vector, which gives rise to the fact that the actual computational complexity of one Grover's rotation in the simulator is O(D2). Therefore, the real computation time of the BGS algorithm in a simulator does not faithfully represent its computation time in a quantum computer. For a fair comparison, the number of rotations of the BGS algorithm was plotted as a surrogate of its computation time in FIG. 3B.

Both the results in FIGS. 3A and 3B show that the computational cost of our proposed BGS gradually increases as D gets larger. However, both the growth rate of the computation time and the growth rate of the numbers of rotations are indeed upper bounded as shown in our theoretical analysis. In FIG. 3A, it was observed that the computation time of running BGS is large even when the number of predictor sets D is small. This computation cost is primarily spent on the quantum machine warm-up.

It was also observed that the computational cost has a large variability, which is attributed to the fact that BGS is a stochastic algorithm. Nevertheless, the advantage of the proposed BGS over the classical algorithm becomes more significant as D gets larger.

b. Performance Selection

To evaluate the subset selection accuracy of the BGS algorithm, it was compared with the best subset selection (BSS) via emulation in a classical computer. For the BSS, the subset with the smallest BIC is selected. One hundred replicated samples of size 1000 are generated according to model (14) for each p={6, 7, . . . , 15}. The frequency of the true subset being selected among 100 replicates is shown in Table 2.

TABLE 2
The percentage of the true subset being selected
among 100 replicates by BSS and proposed BGS.

| Method | p = 6 | p = 7 | p = 8 | p = 9 | p = 10 | p = 11 | p = 12 | p = 13 | p = 14 | p = 15 |
|---|---|---|---|---|---|---|---|---|---|---|
| BSS | 96% | 100% | 99% | 99% | 99% | 99% | 99% | 99% | 98% | 99% |
| BGS | 98% | 99% | 98% | 98% | 98% | 98% | 97% | 99% | 97% | 98% |

It was observed that the frequencies in Table 2 were close or equal to 100% for both BGS and BSS under all settings. The frequencies of the true subset being selected by the BGS are almost as good as those by the BSS.

### 7. Application

The performance of the BGS algorithm is evaluated in two CITE-seq studies. In each study, the dataset is randomly divided into a training dataset, consisting of CITE-seq expressions of 75% of the cells, and a testing dataset consisting of expressions of 25% of the cells. BGS is applied to the training dataset to fit models and select the best subsets, followed by predictions on the testing dataset. This experiment is repeated 100 times.

In each experiment, differential expression methods in the Seurat package V5 (Hao et al. 2023) are applied, offering six options: Wilcoxon Rank Sum test (Seurat-wilcox), Student's t-test (Seurat-t), likelihood-ratio test (Seurat-bimod), ROC analysis (Seurat-roc), a logistic regression-based method (Seurat-LR), and a hurdle model-based method (Seurat-MAST). Additionally, differential expression methods in the SCANPY package V1.9.2 (Wolf, Angerer, and Theis 2018) are used with three options: Wilcoxon Rank Sum test (SCANPY-wilcox), Student's t-test (SCANPY-t), and a logistic regression-based method (SCANPY-LR). Further details are provided Ping Ma, Yongkai Chen, Haoran Lu & Wenxuan Zhong (13 Nov. 2024): Bisection Grover's Search Algorithm and Its Application in Analyzing CITE-seq Data, Journal of the American Statistical Association, DOI: 10.1080/01621459.2024.2404259, Supplementary Material Sections E and F, the contents of which are herein incorporated by reference.

a. Identification of ADTs Associated with the Marker Gene of Interest

A study of human cord blood mononuclear cells (CBMC) conducted by Stoeckius et al. (2017) profiled a total of 8,617 cells, including 1,727 CD14+ monocyte cells, using CITE-seq. For each cell, 13 cell-surface protein markers were quantified via sequencing their corresponding antibody-derived tags (ADTs), and RNA expression levels were measured. Among the sequenced RNA, CD14 RNA was identified as an important immune response gene with a high expression level in some monocytes (Rawat et al. 2021).

The association between the expression level of CD14 RNA and 13 ADTs in CD14+ monocyte cells is examined. The expression data is preprocessed using the Seurat package V5, with further details are described in Ping Ma, Yongkai Chen, Haoran Lu & Wenxuan Zhong (13 Nov. 2024): Bisection Grover's Search Algorithm and Its Application in Analyzing CITE-seq Data, Journal of the American Statistical Association, DOI: 10.1080/01621459.2024.2404259, Supplementary Material Section E, the contents of which are herein incorporated by reference.

The ADTs associated with CD14 RNA are identified through a regression approach (Zhong et al. 2005; Zamdborg and Ma 2009; Liu et al. 2024). Specifically, the expression level of CD14 RNA is regressed on the expression levels of 13 ADTs. The goal is to identify the best subset of ADTs for explaining the variation in CD14 RNA. For each candidate subset of the 13 ADTs, a corresponding linear regression model is fitted to the training dataset, and the Bayesian Information Criterion (BIC) is calculated. The BGS algorithm is then applied to select the best subsets.

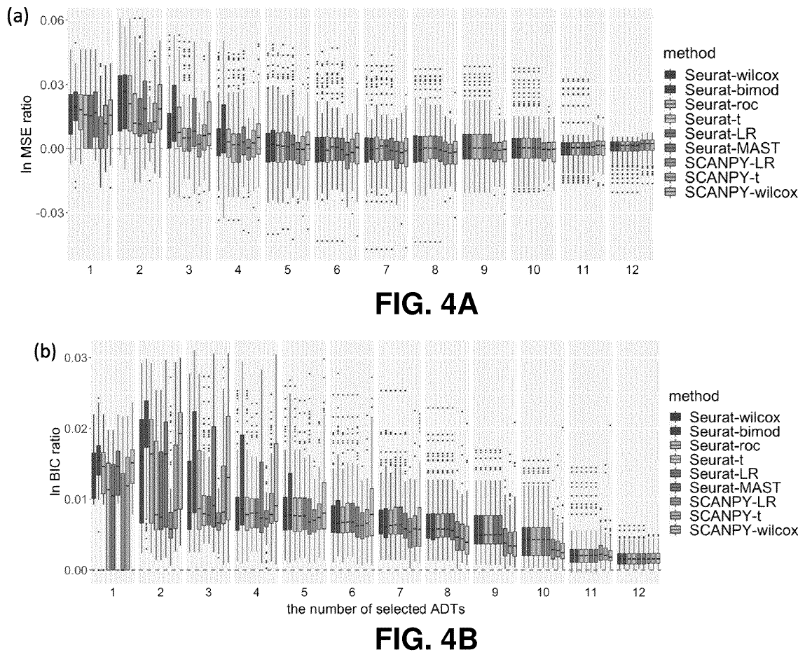

Additionally, the subset of ADTs is selected using the differential expression methods in the Seurat and SCANPY packages. Using the selected subset of ADTs, a linear regression is fitted for CD14 RNA on the training set, and the methods are evaluated based on the mean square error (MSE) between the predicted and observed values of CD14 RNA expression levels in the testing dataset. To ensure a fair comparison, all methods maintain the same number of selected ADTs, ranging from 1 to 12. The natural logarithms of the ratios of the mean squared errors (MSEs) and BIC values of Seurat and SCANPY relative to BGS are computed. The resulting log MSE and BIC ratios are presented in FIGS. 4A and 4B through boxplots. Notably, for all numbers of selected ADTs, most boxplots are positioned above zero. This observation suggests that BGS consistently outperforms the other two methods across various scenarios.

The ADTs associated with CD14 RNA are examined using the BGS algorithm. The best subset of ADTs is selected from 213 possible candidate subsets. The two most significant ADTs associated with CD14 RNA are identified. By fitting a linear regression model using CD4 and CD14 as predictors on all CD14+ monocyte cells, the coefficient of CD4 is found to be −0.1388, while the coefficient of CD14 is 0.1333. CD14 ADT was positively associated with CD14 RNA, which aligns with the fact that CD14 RNA is the coding gene for the CD14 protein. Additionally, a negative relationship between CD4 and CD14 RNA is observed, which is consistent with findings in the existing literature. A study on the clinical outcomes of dedifferentiated liposarcoma patients (Schroeder et al. 2021) also reported a negative relationship between CD4 and CD14.

b. Panel Design for Immune Cell Type Identification

In a CITE-seq experiment, Hao et al. (2021) measured expression levels for 228 ADTs and 33,538 RNAs in 161,764 peripheral blood mononuclear cells (PBMCs). These cells encompassed 57 distinct cell types, which were identified and annotated based on differentially expressed RNAs. Additionally, 10 ADT markers were identified for each cell type.

The performance of the BGS algorithm in identifying panels of ADT markers for classifying various cell types is evaluated. To ensure a fair comparison with the results reported in Hao et al. (2021), the panel size is restricted to be smaller than 10. The focus is on classifying major cell types, specifically those with more than 500 sequenced cells, resulting in 41 cell types of interest. For each cell type of interest, that particular cell type is assigned a label of one, while all other cell types are labeled as zero. This approach results in highly unbalanced cell samples, with significantly fewer cells labeled as one compared to those labeled as zero. To mitigate potential biases arising from unbalanced samples, weighted logistic regression models (King and Zeng 2001) are employed on the training dataset for each candidate panel, accounting for the sample weights. The Bayesian Information Criterion (BIC) is calculated, and the BGS algorithm is applied to identify the best panel with the optimal BIC.

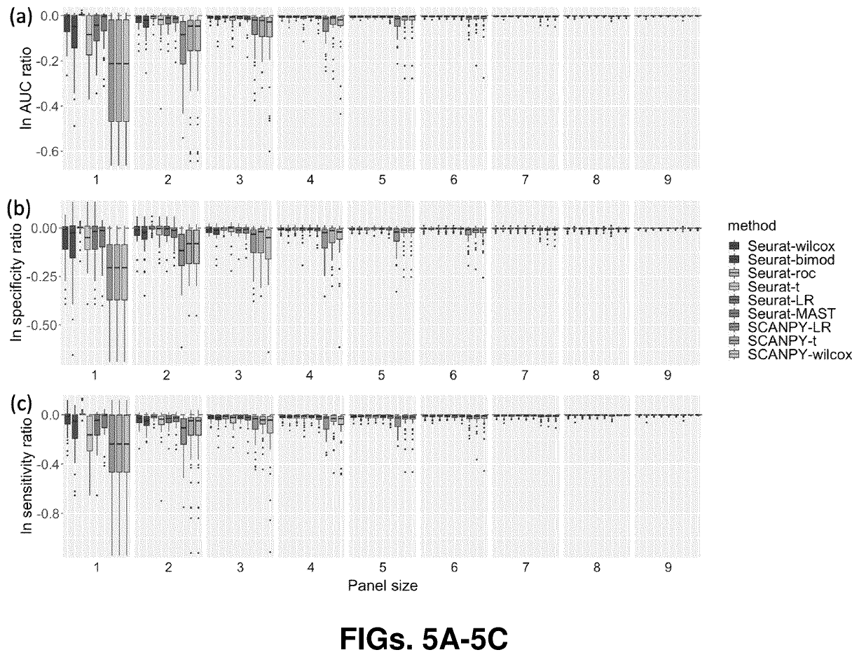

For each of the 41 cell types, the Seurat and SCANPY methods are also used to identify differentially expressed ADTs specific to that cell type using the training dataset. These selected ADTs are then used to fit weighted logistic regression models. Finally, the performance of the fitted models is assessed on the testing dataset by calculating metrics such as the area under the ROC curve (AUC), sensitivity, and specificity. For each of the 41 cell types, the log ratios of the evaluation metrics for the Seurat and SCANPY methods are calculated in comparison to those of the proposed BGS algorithm. A log ratio less than zero indicates that BGS outperforms the corresponding method. The results are visualized using boxplots in FIGS. 5A-5C for AUC, sensitivity, and specificity, respectively.

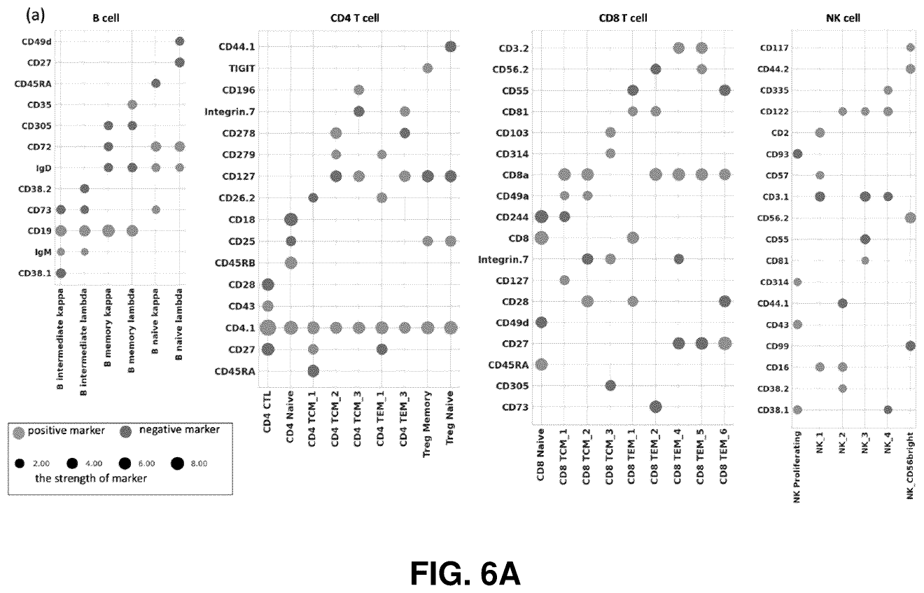

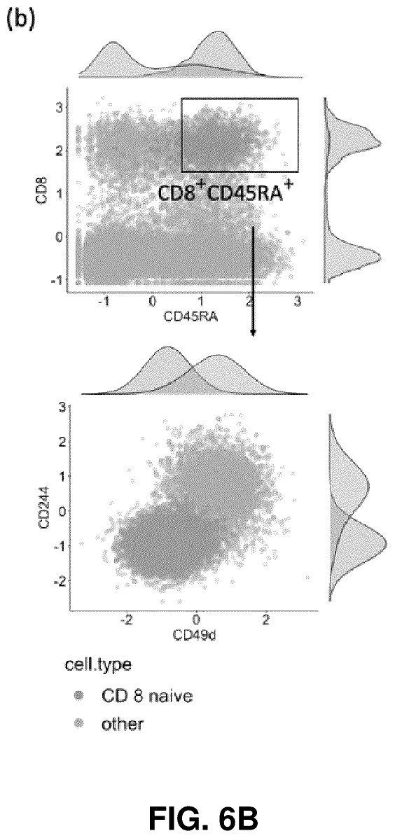

To maintain a reasonable scale of the figure, outliers below the lower bound of the Y-axis are omitted. Across all three metrics and considering the four different panel sizes, the majority of the boxplots are positioned below zero. This observation indicates that BGS consistently outperforms the other methods across a wide range of scenarios. FIG. 6A presents dot plots illustrating the best four-marker panels selected by the BGS algorithm for 30 different cell types, categorized into four major coarse cell types: B cells, CD4 T cells, CD8 T cells, and NK cells. Within each coarse cell type, multiple best panels shared common markers. For example, in the case of CD4 T cells, all best panels included CD4 T as a strong marker. However, when comparing panels across different coarse cell types, distinct marker compositions were observed among the best panels. The marker panels identified by the BGS algorithm align with existing literature. For instance, CD19⁺IgD⁻ are well-known markers for B memory cells, while IgD⁺ serves as a marker for B naive cells (Kaminski et al. 2012). Similarly, CD4⁺CD25⁺CD127⁻ are markers for T regulatory (Treg) cells (Liu et al. 2006), and CD3⁻CD122⁺ are markers for NK cells (Farag and Caligiuri 2006).

Additionally, it was observed that the combined use of CD49d and CD244 as highly informative markers, alongside the typical markers CD8⁺CD45RA⁺ (Nguyen et al. 2016) for identifying CD8 naive T cells. This finding has not been previously reported. While previous studies consistently show that CD8 naive cells generally exhibit low expression levels of both CD49d and CD244, which may increase upon activation, the specific roles and implications of these markers in immune responses have only recently been investigated (White, Cross, and Kedl 2017; Berard and Tough 2002; Agresta, Hoebe, and Janssen 2018).

The upregulation of CD49d enhances efficient access to inflamed peripheral tissues and improves responsiveness to inflammatory signals, while increased CD244 signaling activates CD8 naive T cells. However, using CD244 or CD49d alone may not be sufficient as informative markers, as illustrated by the marginal distributions of CD49d and CD244 for the CD8⁺CD45RA⁺ cell population in FIG. 6B. In contrast, the selected panel (CD8⁺CD45RA⁺CD244⁻CD49d⁻) demonstrated high accuracy in screening CD8 naive cells, as evidenced by an average AUC of 0.998 in the test datasets across 100 replications. Additional results for this study are reported in Ping Ma, Yongkai Chen, Haoran Lu & Wenxuan Zhong (13 Nov. 2024): Bisection Grover's Search Algorithm and Its Application in Analyzing CITE-seq Data, Journal of the American Statistical Association, DOI: 10.1080/01621459.2024.2404259, Supplementary Material Section H, the contents of which are herein incorporated by reference.

The design of the experimental setup was constrained by the available hardware. Consequently, the experiments were conducted on relatively low-dimensional problems. Nonetheless, it was expected that the algorithm would scale effectively and yield more significant insights as quantum computing technology advanced.

### CONCLUSIONS

Many statistical problems involve computationally intensive tasks, leading to growing interest among statisticians in the potential of quantum computers (Wang and Song 2020; Wang and Liu 2022). This raises the question of whether quantum computers can provide benefits in solving statistical or data science problems. If so, an additional consideration is determining the types of statistical problems that should be approached using quantum computing. However, a general answer to this question remains elusive. This study addressed this question by demonstrating the benefits of quantum computing in single-cell biology problems, an area statisticians have extensively explored (Agarwal, Wang, and Zhang 2020). Specifically, the bisection Grover's search algorithm was developed for selecting the best subset, highlighting its advantages in identifying ADTs associated with targeted genes and designing panels for cell type identification. The theoretical properties of the proposed algorithm were established, and its empirical performance was evaluated using a NISQ device and a simulator.

The BGS algorithm was noted for its high versatility and flexibility. It has the potential to be seamlessly integrated into other machine learning methods, such as deep neural networks, which are recognized for their strong fitting capabilities, expressive power, and predictive accuracy (Beer et al. 2020; Abbas et al. 2021). This integration allows researchers to leverage the expressive power of machine learning models while benefiting from the computational efficiencies provided by quantum computing to address more complex problems.

A feature that differentiates quantum algorithms from classical algorithms is quantum parallelism, which facilitates a unique approach to addressing multi-modal biological problems. The potential applications of quantum algorithms in biological research extend well beyond the scope discussed here.

For example, quantum algorithms show promise in improving the analysis of spatial transcriptomics data, facilitating the discovery of new insights and advancing capabilities in the field.

### REFERENCES

Abbas, A., Sutter, D., Zoufal, C., Lucchi, A., Figalli, A., and Woerner, S. (2021), “The Power of Quantum Neural Networks,” Nature Computational Science, 1, 403-409. [11]
Agarwal, D., Wang, J., and Zhang, N. R. (2020), “Data Denoising and Post-Denoising Corrections in Single Cell RNA Sequencing,” Statistical Science, 35, 112-128. [11]
Agresta, L., Hoebe, K. H., and Janssen, E. M. (2018), “The Emerging Role of CD244 Signaling in Immune Cells of the Tumor Microenvironment,” Frontiers in Immunology, 9, 2809. [10]
Arute, E., Arya, K., Babbush, R., Bacon, D., Bardin, J. C., Barends, R., et al. (2019), “Quantum Supremacy Using a Programmable Superconducting Processor,” Nature, 574, 505-510. [1]
Beer, K., Bondarenko, D., Farrelly, T., Osborne, T. J., Salzmann, R., Scheiermann, D., et al. (2020), “Training Deep Quantum Neural Networks,” Nature Communications, 11, 808. [11]
Berard, M., and Tough, D. F. (2002), “Qualitative Differences Between Naive and Memory T Cells,” Immunology, 106, 127. [10]
Biamonte, J., Wittek, P., Pancotti, N., Rebentrost, P., Wiebe, N., and Lloyd, S. (2017), “Quantum Machine Learning,” Nature, 549, 195-202. [3]
Brassard, G., Hoyer, P., Mosca, M., and Tapp, A. (2002), “Quantum Amplitude Amplification and Estimation,” Contemporary Mathematics, 305, 53-74. [3]
Brassard, G., Hoyer, P., and Tapp, A. (1998), “Quantum Counting,” in International Colloquium on Automata, Languages, and Programming, pp. 820-831, Springer. [5]
Castelvecchi, D. (2023), “IBM Releases First-Ever 1,000-Qubit Quantum Chip,” Nature, 624, 238-238. [1]
Chakraborty, S., Shaikh, S. H., Chakrabarti, A., and Ghosh, R. (2020), “A Hybrid Quantum Feature Selection Algorithm Using a Quantum Inspired Graph Theoretic Approach,” Applied Intelligence, 50, 1775-1793. [2]
Farag, S. S., and Caligiuri, M. A. (2006), “Human Natural Killer Cell Development and Biology,” Blood Reviews, 20, 123-137. [10]
Ferrer-Font, L., Small, S. J., Lewer, B., Pilkington, K. R., Johnston, L. K., Park, L. M., et al. (2021), “Panel Optimization for High-Dimensional Immunophenotyping Assays Using Full-Spectrum Flow Cytometry,” Current Protocols, 1, e222. [2]
Grover, L. K. (1996), “A Fast Quantum Mechanical Algorithm for Database Search,” in Proceedings of the Twenty-Eighth Annual ACM Symposium on Theory of Computing, STOC '96, New York, NY, USA, pp. 212-219, Association for Computing Machinery. [3]
Hao, Y., Hao, S., Andersen-Nissen, E., Mauck, W. M., Zheng, S., Butler, A., et al. (2021), “Integrated Analysis of Multimodal Single-Cell Data,” Cell, 184, 3573-3587. [2,8,10,11]
Hao, Y., Stuart, T., Kowalski, M. H., Choudhary, S., Hoffman, P., Hartman, A., et al. (2023), “Dictionary Learning for Integrative, Multimodal and Scalable Single-Cell Analysis,” Nature Biotechnology, 42, 293-304. [8]
He, Z., Li, L., Huang, Z., and Situ, H. (2018), “Quantum-Enhanced Feature Selection with Forward Selection and Backward Elimination,” Quantum Information Processing, 17, 1-11. [2]
Kaminski, D. A., Wei, C., Qian, Y., Rosenberg, A. F., and Sanz, I. (2012), “Advances in Human B Cell Phenotypic Profiling,” Frontiers in Immunology, 3, 302. [10]
King, G., and Zeng, L. (2001), “Logistic Regression in Rare Events Data,” Political Analysis, 9, 137-163. [10]
Koike, I., and Okudaira, Y. (2009), “Time Complexity and Gate Complexity,” Physical Review A, 82, 042305. [7]
Li, Y., Zhou, R.-G., Xu, R., Luo, J., Hu, W., and Fan, P. (2022), “Implementing Graph-Theoretic Feature Selection by Quantum Approximate Optimization Algorithm,” IEEE Transactions on Neural Networks and Learning Systems, 35, 2364-2377. [2]
Liu, W., Putnam, A. L., Xu-Ya, Z., Szot, G. L., Lee, M. R., Zhu, S., et al. (2006), “CD127 Expression Inversely Correlates with Foxp3 and Suppressive Function of Human CD4⁺ T Reg Cells,” The Journal of Experimental Medicine, 203, 1701-1711. [10]
Liu, Y., Chen, Y., Lu, H., Zhong, W., Yuan, G.-C., and Ma, P. (2024), “Orthogonal Multimodality Integration and Clustering in Single-Cell Data,” BMC Bioinformatics, 25, 164. [8]
Mücke, S., Heese, R., Müller, S., Wolter, M., and Piatkowski, N. (2023), “Feature Selection on Quantum Computers,” Quantum Machine Intelligence, 5, 11. [2]
Nguyen, H. H., Kim, T., Song, S. Y., Park, S., Cho, H. H., Jung, S.-H., et al. (2016), “Naïve CD8⁺ T Cell Derived Tumor-Specific Cytotoxic Effectors as a Potential Remedy for Overcoming TGF-β Immunosuppression in the Tumor Microenvironment,” Scientific Reports, 6, 1-10. [10]
Nielsen, M. A., and Chuang, I. L. (2010), Quantum Computation and Quantum Information, Cambridge: Cambridge University Press. [1,4]
Preskill, J. (2018), “Quantum Computing in the NISQ Era and Beyond,” Quantum, 2, 79. [1]
Rawat, K., Pal, A., Banerjee, S., Pal, A., Mandal, S. C., and Batabyal, S. (2021), “Ovine CD14—an Immune Response Gene Has a Role Against Gastrointestinal Nematadode”, Frontiers in Immunology, 12, 664877 [8]
Schroeder, B. A., LaFranzo, N. A., LaFleur, B. J., Gittelman, R. M., Vignali, M., Zhang, S., et al. (2021), “CD4⁺ T Cell and M2 Macrophage Infiltration Predict Dedifferentiated Liposarcoma Patient Outcomes,” Journal for Immunotherapy of Cancer, 9, e002812. [8]
Schuld, M., Sinayskiy, I., and Petruccione, F. (2016), “Prediction by Linear Regression on a Quantum Computer,” Physical Review A, 94, 022342. [3]
Schwarz, G. (1978), “Estimating the Dimension of a Model,” The Annals of Statistics, 6, 461-464. [2]
Shor, P. W. (1999), “Polynomial-Time Algorithms for Prime Factorization and Discrete Logarithms on a Quantum Computer,” SIAM Review, 41, 303-332. [1]
Stoeckius, M., Hafemeister, C., Stephenson, W., Houck-Loomis, B., Chattopadhyay, P. K., Swerdlow, H., et al. (2017), “Large-Scale Simultaneous Measurement of Epitopes and Transcriptomes in Single Cells,” Nature Methods, 14, 865. [2,8,11]
Turati, G., Dacrema, M. F., and Cremonesi, P. (2022), “Feature Selection for Classification with QAOA,” in 2022 IEEE International Conference on Quantum Computing and Engineering (QCE), pp. 782-785, IEEE. [2]
Von Dollen, D., Neukart, F., Weimer, D., and Bick, T. (2021), “Quantum-Assisted Feature Selection for Vehicle Price Prediction Modeling,” arXiv preprint arXiv: 2104.04049. [2]
Wang, Y. (2022), “When Quantum Computation Meets Data Science: Making Data Science Quantum,” Harvard Data Science Review, 4. DOI: 10.1162/99608192.ef5d8928. [1]
Wang, Y., and Liu, H. (2022), “Quantum Computing in a Statistical Context,” Annual Review of Statistics and Its Application, 9, 479-504.
Wang, Y., and Song, X. (2020), “Quantum Science and Quantum Technology,” Statistical Science, 35, 51-74.
White, J. L., Cross, E. W., and Kedl, R. M. (2017), “Antigen-Inexperienced Memory CD8⁺ T Cells: Where They Come From and Why We Need Them,” Nature Reviews Immunology, 17, 391-400. [10]
Wolf, F. A., Angerer, P., and Theis, F. J. (2018), “Scanpy: Large-Scale Single-Cell Gene Expression Data Analysis,” Genome Biology, 19, 1-5. [8]
Wootters, W. K., and Zurek, W. H. (1982), “A Single Quantum Cannot Be Cloned,” Nature, 299, 802-803. [5]
Wu, Y., Bao, W.-S., Cao, S., Chen, F., Chen, M.-C., Chen, X., et al. (2021), “Strong Quantum Computational Advantage Using a Superconducting Quantum Processor,” Physical Review Letters, 127, 180501. [1]
Zamdborg, L., and Ma, P. (2009), “Discovery of Protein-DNA Interactions by Penalized Multivariate Regression,” Nucleic Acids Research, 37, 5246-5254. [8]
Zhong, H.-S., Wang, H., Deng, Y.-H., Chen, M.-C., Peng, L.-C., Luo, Y.-H., et al. (2020), “Quantum Computational Advantage Using Photons,” Science, 370, 1460-1463. [1]
Zhong, W., Zeng, P., Ma, P., Liu, J. S., and Zhu, Y. (2005), “RSIR: Regularized Sliced Inverse Regression for Motif Discovery,” Bioinformatics, 21, 4169-4175. [8]

It is understood that the disclosed method and compositions are not limited to the particular methodology, protocols, and reagents described as these can vary. It is also to be understood that the terminology used herein is for the purpose of describing particular embodiments only, and is not intended to limit the scope of the present invention which will be limited only by the appended claims.

Those skilled in the art will recognize, or be able to ascertain, using no more than routine experimentation, many equivalents to the specific embodiments of the method and compositions described herein. Such equivalents are intended to be encompassed by the following claims.

We claim:

1. A computer-implemented system (CIS) comprising an ensemble of algorithms comprising a quantum search algorithm operably linked to a processor comprising quantum bits and/or quantum gates, wherein the ensemble of algorithms is configured to enhance computing efficiency using the processor compared to a classical optimal search algorithm for a corresponding dataset,
wherein the ensemble of algorithms is configured to select a first smaller dataset from a second dataset, by:
(a) generating substates corresponding to subsets of data in the second set of data,
(b) selecting from the substates a first substate as an initial best state and calculating a value for the first substate via a statistical model selection criterion,
(c) partitioning all substates into at least two partitions comprising oracle states and non-oracle states, based on the value of the statistical model selection criterion for the first substate, and/or
(d) performing one or more operations to generate a new substate and a value calculated for its statistical model selection criterion, wherein the new substate replaces and becomes the first substate as a best state if the calculated value for its statistical model selection criterion is less than the calculated value for the first substate's statistical model selection criterion, optionally wherein all of steps (a), (b), (c), and (d) are performed.

2. The CIS of claim 1, wherein the ensemble of algorithms is configured to select the first state from a random selection of substates, by selecting the substate with the smallest statistical model selection criterion in the random selection of substates.

3. The CIS of claim 1, wherein the ensemble of algorithms is operably linked to a user interface, optionally a quantum-classical interface, and configured to output to the user interface:
(i) data corresponding to the first set of data as the first smaller dataset when the first substate can no longer be replaced by another generated new substate in a subsequent iteration, or
(ii) data corresponding to the first substate as the first smaller dataset, when the oracle states are a null set.

4. The CIS of claim 1, wherein the ensemble of algorithms comprises a quantum amplitude amplification algorithm, a binary search algorithm, and a quantum counting algorithm.

5. The CIS of claim 1, wherein the ensemble of algorithms is configured to bisect all substates into two partitions with one partition comprising oracle states and another partition comprising non-oracle states.

6. The CIS of claim 1, wherein the one or more operations comprise performing (i) a first superposition of all states to form a first state vector, (ii) a second superposition of the oracle states to form a second state vector, and (iii) a third superposition of the non-oracle states to form a third state vector.

7. The CIS of claim 6, wherein the one or more operations comprise determining an angle between the first state vector and the third state vector.

8. The CIS of claim 7, wherein:
(i) determining the angle between the first state vector and the third state vector comprises using the quantum counting algorithm, or
(ii) the one or more operations comprise determining a number of times to iterate one or more processes in the ensemble of algorithms based on the angle between the first state vector and the third state vector.

9. The CIS of claim 8, wherein determining the number of times to iterate one or more processes in the ensemble of algorithms comprises using the quantum counting algorithm.

10. The CIS of claim 6, wherein the one or more operations comprise rotating the first state vector toward the second state vector to form a rotated superposition.

11. The CIS of claim 10, wherein:
(i) rotating the first state vector toward the second state vector comprises a mathematical flip operation, a mathematical diffusion operation, or a combination thereof, or
(ii) the one or more operations comprises measuring the rotated superposition and forming the new substate.

12. The CIS of claim 7, wherein the ensemble of algorithms is configured to iterate steps (c) and (d) until a sine value of the angle between the first state vector and the third state vector is less than an error tolerance.

13. The CIS of claim 1, wherein the second dataset comprises biological data, medical records data, financial variables data, image classification data, stock market data, customer segmentation data, or a combination thereof.

14. The CIS of claim 1, wherein the second dataset comprises biological data.

15. The CIS of claim 1, wherein the ensemble of algorithms is configured to calculate one or more values of the statistical selection criterion by fitting a regression model to a substate.

16. The CIS of claim 1, wherein the statistical model selection criterion comprises a Bayesian information criterion, Akaike information criterion, corrected Akaike information criterion, consistent Akaike information criterion, deviance information criterion, cross-validation, likelihood ratio test, information complexity, generalized information criterion, Hanna-Quinn information criterion, minimum description length, or a combination thereof.

17. The CIS of claim 1, wherein the statistical model selection criterion comprises a Bayesian information criterion.

18. The CIS of claim 1, wherein the ensemble of algorithms comprises a state loss function configured to map a state for generated substates.

19. The CIS of claim 1, operably linked to a machine learning platform.

20. A non-transitory computer-readable medium comprising one or more computer-executable instructions stored thereon executed by a processor comprising quantum bits (qubits) and/or quantum gates, wherein the one or more computer-executable instructions comprise an ensemble of algorithms operably linked to the processor, wherein the ensemble of algorithms is configured to enhance computing efficiency using the processor compared to a classical optimal search algorithm for a corresponding dataset,
wherein the ensemble of algorithms is configured to select a first smaller dataset from a second dataset in the absence of an oracle function, by:
(a) generating substates corresponding to subsets of data in the second set of data,
(b) selecting from the substates a first substate as an initial best state and calculating a value for the first substate via a statistical model selection criterion,
(c) partitioning all substates into at least two partitions comprising oracle states and non-oracle states, based on the value of the statistical model selection criterion for the first substate, and/or
(d) performing one or more operations to generate a new substate and a value calculated for its statistical model selection criterion, wherein the new substate replaces and becomes the first substate as a best state if the calculated value for its statistical model selection criterion is less than the calculated value for the first substate's statistical model selection criterion, optionally wherein all of steps (a), (b), (c), and (d) are performed.

21. A computer-implemented method (CIM) for selecting a first smaller dataset from a second dataset, the CIM comprising:
processing data corresponding to the second dataset using the CIS claim 1.

22. The CIM of claim 21, wherein the data corresponding to the second dataset is in the form of an orthonormal basis set comprising substates corresponding to subsets of data in the second dataset.
